(19) United States
(12) Patent Application Publication
(10) Pub. No.: US 2016/0014057 A1
(43) Pub. Date: Jan. 14, 2016

(54) METHOD AND SYSTEM FOR PROVIDING DYNAMICALLY CUSTOMIZED WEB PUSH MESSAGES IN A WIRELESS NETWORK

(71) Applicant: Samsung Electronics Co., Ltd., Suwon-si (KR)

(72) Inventors: Suresh Kumar GUDLA, Bangalore (IN); Joy BOSE, New Delhi (IN)

(21) Appl. No.: 14/793,107

(22) Filed: Jul. 7, 2015

(30) Foreign Application Priority Data
Jul. 8, 2014 (IN) 3367/CHE/2014

(51) Int. Cl. H04L 12/58; H04L 29/08

(52) U.S. Cl. CPC H04L 51/046; H04L 67/26

(57) ABSTRACT

The present invention describes a method and system for providing dynamically customized web push messages in a wireless network. The method comprises receiving at least one push message from at least one content provider, customizing the at least one push message based on one or more instructions stored in a gateway server, and pushing the at least one push message to at least one user device, based on the customization of the at least one push message at the gateway server. The system comprises at least one content provider, at least one push server, a gateway server, and at least one user device.

### CROSS-REFERENCE TO RELATED APPLICATION(S)

This application claims the benefit under 35 U.S.C. §119(a) of Indian Provisional Application filed on Jul. 8, 2014 in the Indian Patent Office and assigned serial number 3367/CHE/2014, Indian Patent Application filed on Apr. 25, 2015 in the Indian Patent Office and assigned serial number 3367/CHE/2014, and Indian Patent Application filed on Jul. 3, 2015 in the Indian Patent Office and assigned serial number 3367/CHE/2014, the entire disclosure of which is hereby incorporated by reference.

### TECHNICAL FIELD

The present disclosure generally relates to communication devices and more particularly relates to method and system for providing dynamically customized web push messages to user device in a wireless network.

### BACKGROUND

Nowadays there are a few kinds of web push notifications that are available to users, such as Apple push notifications (a proprietary mechanism for the Safari browser), Mozilla simple push, W3C Push API for web apps and GCM Push for Google Chrome.

There are mainly three existing systems with respect to Web Push Notifications: Mozilla Push Notification system, Apple Push Notification and Push Messaging in Chrome.

Mozilla push notification system is implemented with w3c editorial draft for web-apps. This framework is tightly coupled with web-apps and is based on light weight simple push mechanism. Each individual web app has to register for push notification messages and has to process the light weight Simple push messages received later, judge and then decide whether to display to user or not.

But, the Mozilla push notification system is having limitations such as:
Mozilla OS supports push message registering and receiving for web-apps. This is not the case w.r.t platforms like Android.
Mozilla has implemented Simple Push message which mandates the web-app to connect to App server upon arrival of every push message. This adds to extra Power consumption and always a Data connectivity is needed.

Apple push notification is another well-established web push notification system, which is completely proprietary standard and supports full Push messages. Apps when opened in Safari browser has option to register with Push server and get Push messages later as sent from their app server. When a new push message comes notification will be displayed to user.

But, the Apple push notification is having drawbacks such as:
All the push messages will be directed to Notification center without much validation option by apps.
Proprietary standard and is not easily adaptable to other platforms
Man in the middle attacks is possible with this approach.
User login authentication is not possible with this approach.

Push Messaging in Chrome: Google chrome has implemented push messaging based on service worker implementation however they do not address all the extended features and very much limited to the usage of Google cloud messaging. They are referring to the evolving W3C Push Api and adhered to use https in service worker which is mandated but not needed always.

Drawbacks:
All the push messages will be directed to Notification center without much validation option by apps.
A service worker has always has to run or maintained at engine side for wake up.
User login authentication is not possible with this approach.
Extended UI or integration with native apps is not possible with this approach

Thus, in the current scenario there is no existing system to receive Web Push Notifications for embedded devices without the need of individual web-apps or additional extensions or plugins. Also, there is no way to achieve the web push notifications without compromising on Power and Performance, and ensure security at the same time.

In view of the foregoing, there is a need to provide a system and method for web push messages/notifications for embedded devices where the content provider can customize the kind and frequency of the messages/notifications pushed to the user device. Further, there is need for a system that receives web push messages/notifications for embedded devices (such as smart phone) without the need of individual web-apps or additional extensions or plugins. Also, there is need for a method to achieve the web push messages/notifications without compromising on Power and Performance, and ensure security at the same time.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure describes a method of providing dynamically customized web push messages in a wireless network. The method comprises receiving at least one push message from at least one content provider, customizing the at least one push message based on one or more instructions stored in a gateway server, and pushing the at least one push message to at least one user device, based on the customization of the at least one push message at the gateway server.

Another aspect of the present disclosure describes a system for providing dynamically customized web push messages in a wireless network. The system comprises at least one content provider, at least one push server for pushing the at least one push message to at least one user device, a gateway server coupled to the at least one content provider, the at least one push server, and the at least one user device having a gateway client for customizing the at least one push message based one or more instructions stored at the gateway server.

Another aspect of the present disclosure describes a method of dynamically customizing at least one push message from a content provider based on one or more instructions. The method comprises retrieving information of at least one user device by a gateway client of the corresponding user device, defining a set of rules dynamically by a gateway server based on the retrieved information of the at least one user device, and regulating transmission of the at least one push message by at least one of the content provider and the gateway server based on the defined set of rules.

Another aspect of the present disclosure describes a method of popping up at least one push message from a plurality of stored message in a user device. The method comprises analyzing information of user device, wherein the information comprises at least one of a location of the user device, Real time web browsing activity perfumed in the user device and, calendar schedule stored in the user device, fetching at least one push message from a plurality of stored message in a user device corresponding to analyzed information, and displaying the fetched at least one push message.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The objects above and other aspects, features, and advantages of certain embodiments of the present invention disclosure will be more apparent from the following detailed description taken in conjunction with the accompanying drawings, in which:

FIG. 1 illustrates a schematic diagram of a system for providing dynamically customized web push messages in a wireless network according to an embodiment of the present invention.

FIG. 2 illustrates a schematic diagram of a system for providing dynamically customized web push messages in a wireless network according to an embodiment of the present invention.

FIG. 3 illustrates architecture of the system 100 for providing dynamically customized web push messages in a wireless network according to an embodiment of the present invention.

FIGS. 4A and 4B illustrates a system for providing dynamically customized web push messages showing region based ads as per the user's region or location in a wireless network according to an exemplary embodiment of the present invention.

FIG. 5 illustrates a system for providing dynamically customized web push messages showing service provider recommendations based on user profile according to an exemplary embodiment of the present invention.

FIG. 6 illustrates a system for providing dynamically customized web push messages showing changing frequency of recommendation as per device status according to an exemplary embodiment of the present invention.

FIG. 7 illustrates a system for providing dynamically customized web push messages showing push messages getting automatically deleted based on an expired time stamp according to an exemplary embodiment of the present invention.

FIG. 8 illustrates a system for providing dynamically customized web push messages showing redirection of push messages to another device according to an exemplary embodiment of the present invention.

FIG. 9 illustrates a flow chart of a method of providing dynamically customized web push messages in a wireless network according to an embodiment of the present invention.

FIG. 10A to 10C illustrates a flow diagram a method of dynamically customizing at least one push message from a content provider according to an embodiment of the present invention.

FIGS. 11A and 11B illustrates a security feature in the customized web push messages in a wireless network according to an embodiment of the present invention.

FIGS. 12A and 12B illustrates a seamless web push messages in a wireless network according to an embodiment of the present invention.

FIGS. 13A and 13B illustrates an embodiment of displaying previously stored push message relevant to the user web browsing activity according to the present invention.

FIG. 14A to 14C illustrates a method of dynamically customizing the at least one push message from a content provider based on feedback received from one or more connected devices according to the present invention.

FIG. 15 illustrates a user interface for enabling the user to configure settings according to advanced push features according to an embodiment of the present invention.

FIG. 16 illustrates the main push APIs for subscription, feedback update and profile.

### DETAILED DESCRIPTION

The embodiments of the present invention will now be described in detail with reference to the accompanying drawings. However, the present invention is not limited to the embodiments. The present invention can be modified in various forms. Thus, the embodiments of the present invention are only provided to explain more clearly the present invention to the ordinarily skilled in the art of the present invention. In the accompanying drawings, like reference numerals are used to indicate like components.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention describes method and system for providing dynamically customized web push messages to embedded devices (such as smart phones) with the help of an extended browser application in a wireless network. The system and method can be easily adapted to any other platform ensuring better power, performance and security and thus avoiding the need for individual apps in the phone.

The push messaging feature enables users to receive important messages and ads from the gateway server to client without the need of client getting connected to the server always. The push messaging methods are proprietary standards where in each and every application having their own logic of getting the push messages by keeping their applications or web-apps online or off line.

In one embodiment, the applications have option to process directly the new push message or can decide to send to notification center without processing, thus enabling power and performance as required for embedded devices. The method and system of the present invention addresses the limitations of prior art such as address fragmentation problems, power problems, memory problems and security problems in real time scenarios.

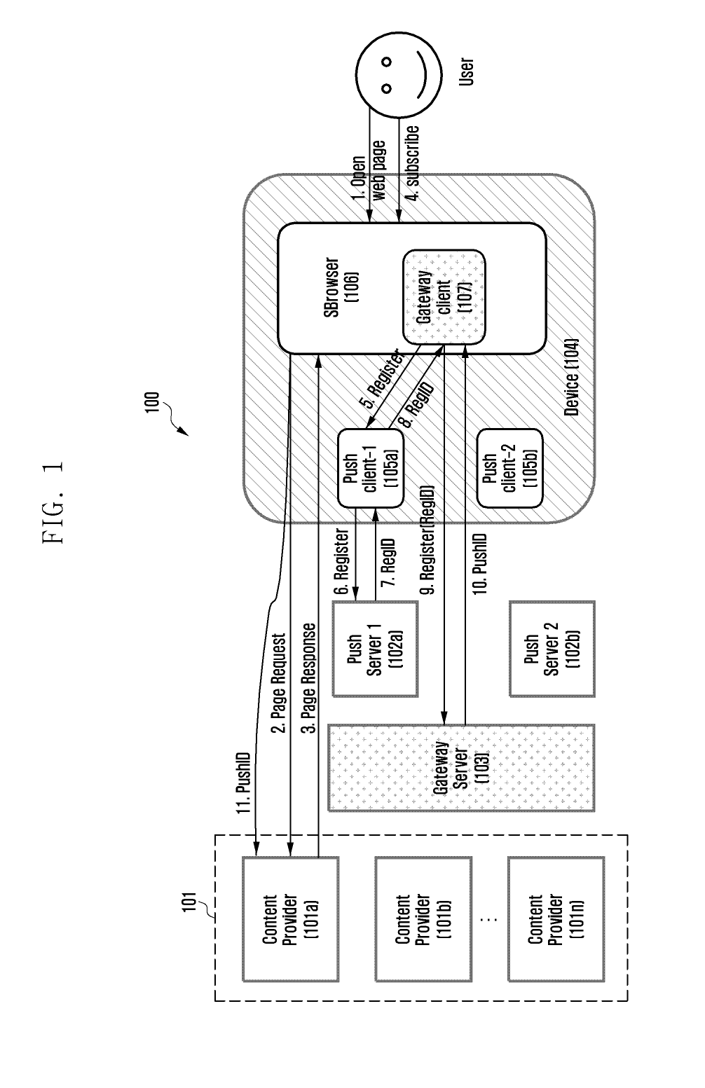

FIG. 1 illustrates a schematic diagram of a system 100 for providing dynamically customized web push messages in a wireless network according to an embodiment of the present invention. The system 100 comprises one or more content providers 101 (such as 101a, 101b, . . . , 101n), one or more push servers 102 (such as 102a, 102b), and a gateway server 103. The push server 102 is configured for pushing the at least one push message to at least one user device 104. The gateway server 103 is connected to the one or more content providers 101, one or more one push servers 102, and the one or more user devices 104. The user device 104 includes a gateway client 107 for customizing the one or more push messages based on receiving one or more instructions stored at the gateway server 103. The push server and push provider are used interchangeably throughout the specification.

The gateway server 103 and the gateway client 107 are designed to become OS agnostic and Push Provider agnostic. The gateway server 103 adopts many of the content recommendations features and the push data dealings with the content providers 101. The gateway client 107 provides many push specific features such as extended push UI, push inbox, extended push settings, push configuration of connected devices, push profiles of content providers, push widgets, push privacy of content providers and user, etc.

According to one embodiment, a process of registering PushID is described in FIG. 1. User opens web page using a browser 106. The browser 106 sends a page opening request to the content provider 101. The content provider 101 sends page opening response to the browser 106. Then the user subscribes with the content provider 101. The gateway client sends a registration request to the push server 102 through a push client 105. The push server 102 sends a RegID to the gateway client 107 through the push client 105. The gateway client registers with the gateway server 103 using RegID. The gateway server 103 provides a PushID to the gateway client 107. In turn the browser sends the PushID to the content provider 101.

In this present system 100, the applications can be opened via an extended browser which supports additional functionality required for embedded devices apart from the w3c editorial draft. The extended browser is configured to support the below features:

a) An Associated URI (uniform resource identifier) of the Application is shared during registration which handles the newly received push message at a later point
This Associated URI has native JS (Java Script) implementation or service worker based implementation which receives the new push message.
Using this Associated URI based on the parameters mentioned in the push message App has to either authenticate user credentials or can get details of the message directly from its app server when treated as more secure.

b) When a new Push message comes it carries the basic data such as title, icon URL, body, expiration data, basic authentication data to identify the device and the target Browser application. Additionally, the push message also contains message type and its corresponding data. The following operations are needed when a new push message is received
If the message is non-secure then it has simple Reference URI which can be launched upon user selection. This approach is primarily needed when accommodating apps in retail market.
If the message is secure then it has App-Data to provoke the notification handler service to get the data authenticated by JS handlers as suggested by Associated URI.
If strict authentication is needed then Associated URI has mechanism to prompt user to enter credentials to authenticate. This approach is primarily needed when mail apps are served.

Considering a scenario where user is having an e-mail account, receives nearly 20 push based messages. If all 20 are sent directly to Notification center then there is no security addressed. If all 20 are directly allowed to be handled by Browser then there will be a huge power surge. So if there is a hybrid approach it will definitely give more security and power saving and thus avoids fragmentation by using multiple apps.

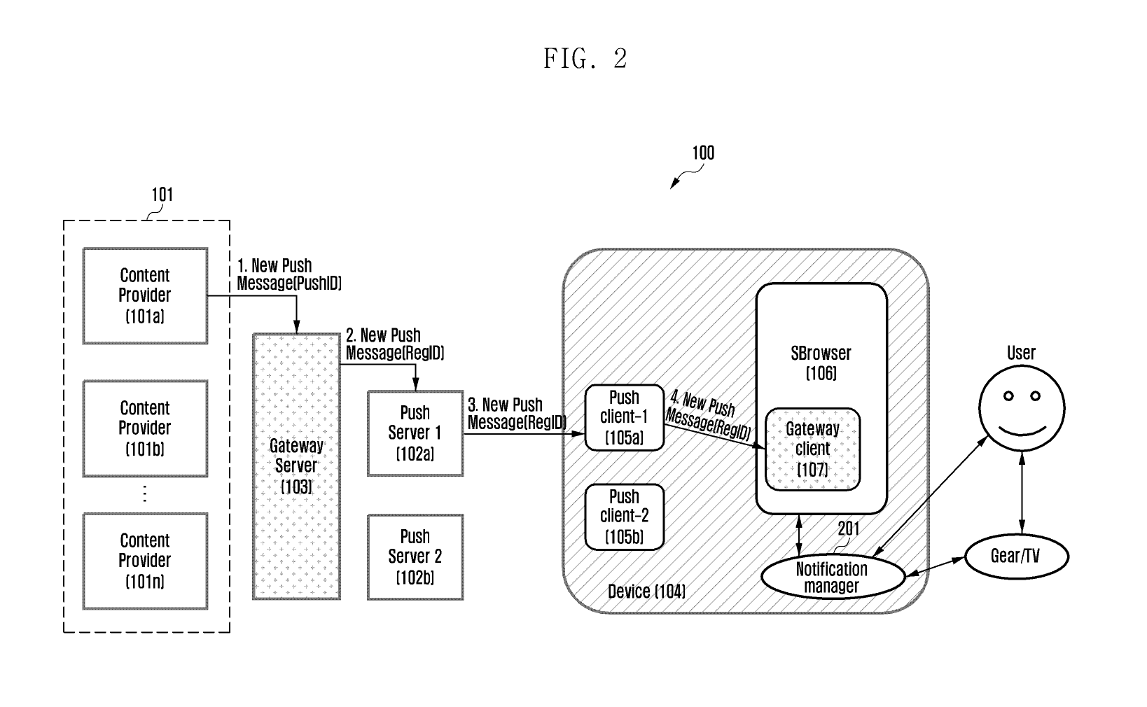

FIG. 2 illustrates a schematic diagram of a system for providing dynamically customized web push messages in a wireless network according to an embodiment of the present invention. In this embodiment, the figure describes a process of providing new push message from the content provider 101 to the gateway client 107. The content provider sends a new push message to the gateway server 103. The gateway server sends new push message with RegID to a Push server 102a. The Push server 102a sends new push message with RegID to the gateway client 107 through the push client 105. The gateway client forwards the message to a notification manager 201. The notification manager 201 sends the message to user or connected device, for example note, gear or TV. The notification manager 201 may be implemented by module included by the device 104. According to another embodiment of the invention, the notification manager 201 may be implemented by separate entity, for example a server.

The gateway server 103 is platform agnostic and decides which push server 102 to communicate with a device of any platform and sends the push message received from the content provider 101. The gateway server 103 decides when to send the push messages based on the device statistics it has and based on the push data analytic information it can customize the push message as per the user profile it has.

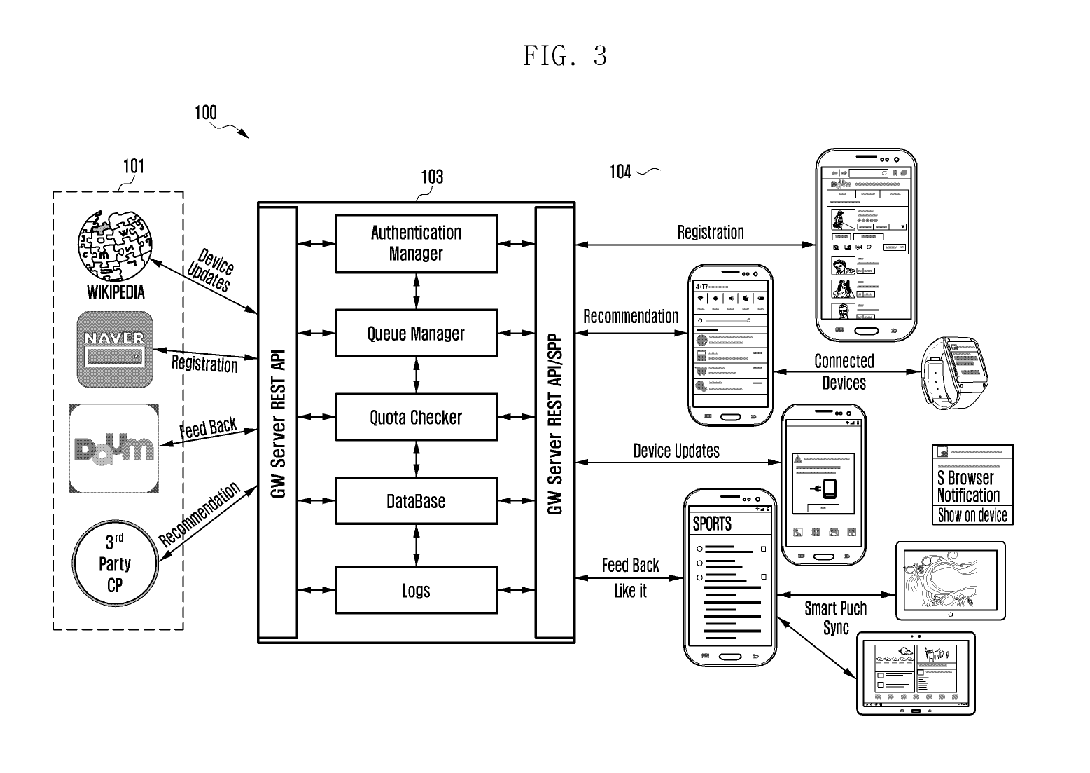

FIG. 3 illustrates architecture of the system 100 for providing dynamically customized web push messages in a wireless network according to an embodiment of the present invention. In this embodiment, the gateway server 103 comprises an authentication managing module, a queue managing module, a quota checking module, a database, and a log module. The authentication managing module authenticates the user during wireless communication between the user devices and the content provider. The queue managing module facilitates the exchange messages/information between the user device and the content provider. The quota checking module ensures sharing of resources among users according to predefined instructions. The database stores the communication messages exchanged between the user device and the content provider. The log module maintains the details of communication between the user device and the content provider.

The gateway server 103 is connected one or more content providers 101 (such as 101a, 101b, 101c, 101d) at one side and one or more user devices on the other side. In this system, the Gateway server along with a gateway client handles many domains where push messages are used. Such domains include convergence, wearables, context recommendations, user recommendations and user privacy. The gateway server 103 communicates via REST APIs with the content providers 101 as well as the user devices and this provides a standard framework so that any change in the push providers will not change the standard interfaces.

Application Program Interface (API):

According to an embodiment of the present invention, the following application program interfaces (APIs) are added or modified in the W3C standard for providing dynamically customized web push messages to user devices in a wireless network:
Update after register
Reupdate
Join
Dynamic Pass URL during register( ) and update( ) APIs
Target URL in New Push Message
Service Icon during register( ) and update( ) APIs
Pass User Agent ID (App Data) during register
Features for Connected Devices: for example note and gear. Apps have no knowledge of connected devices, so message customization will be internally handled by Browser App.
Message Expiry field in New Push Message
Options for the new push messages: group, category, filter

The brief description of each of the above mentioned APIs are provided below:

1. Updates after Register

This is an API that handles the dynamic functionality of the web apps service. If this feature is not present, the user has to unregister and register multiple times to get new content. So this feature is essential for the extended functionalities that we are supporting, such as service icons, pass URLs etc. This update is from HTML page to the engine, to update the existing resources data.

2. Reupdate( )

This reupdate functionality is triggered in a variety of conditions such as low battery, context (e.g. the user has just gone from home to office, time of day is changed etc) or some user actions. This functionality is from the web engine of the browser to the content provider.

In one example, the gateway server monitors the level/status of battery and informs the same to the content provider in order to reduce the frequency of push messages to be provided and provides only the important push messages to the user device.

In another example, the user has subscribed for updates of camera from an online shopping website A during reupdate depending on user preferences; it may notify another online shopping website B also to provide camera related messages.

3. Join ( )

The join method enables existing services to share links with new services. So when new services come they can collaborate with existing service providers to share their infrastructure and resources. So instead of multiple messages, the user gets a single group message from the service provider which can be parsed to multiple messages.

This mechanism/process saves the user data usage and power as well as cost for the content provider. For example, all finance messages are grouped while sending and receiving and while displaying to user they can be stripped apart.

This can be implemented by using the join ( ) method provided by client. Using this one content provider can use an existing the content provider's eco system. This will also enable sending of group messages and client should be able to process them together.

4. Pass URL During Register ( ):

In the state of the art, Mozilla® has this feature internally but this is not part of W3C, also Mozilla's feature is static not dynamic as in the present invention. Any app can dynamically change URL, so in this way the present invention allows dynamic customization.

For example Mozilla® Web-apps have mechanism to register for Push messages and the page to handle push messages via config.xml whereas there is no mechanism for

Browser Application to avoid this limitation of dependency on Platform if Apps (e.g.: Tab's having URLs) can have option to register their Pass URL (URL which handles the new Push message) it will help the necessary Apps to handle on need basis.

Currently in SBrowser Web Push Notification feature case, the system of the present invention sends the new push message to Notification Manager directly and not sending back to Apps. This mechanism helps for doing extra validation of the message (secure messages) if required by the Apps.

5. Target URL in New Push Message:

Currently Push Message has data object as deserialized JSON Object.

In this approach if JSON Attribute and their values (optional, mandatory) are not defined, eventually everyone will end up having their own naming conventions which will not be a good practice. In Browser Web Push Notification feature case also, the system recommends to have Target URL in New Push message if there is a direct link rather than domain URL. For example: An online shopping web site Advertisement having direct search result.

6. Service Icon During Register:

Currently details about icons are not given in W3C.

Apple® push notification has details about icons but this is proprietary to their browser, not a standard. Apple® downloads the icon during service certification package download whereas the browser app of the present system does not download the icon whenever new push message comes. This saves extra fetches from the servers.

In one embodiment, the present system uses favicon/touch icon/icon generation services.

Based on the Apps implementation which has chosen default service icon, Push message will become light weight (no image URL)

7. Pass User Agent ID (App Data) During Register:

A few use cases to handle:

a) Multi instances of Apps (currently w3c supports single registration): From Standards point of View for example if Browser App wants additional information for re-directing, it can be stored.

b) Connected Devices: Apps have no knowledge of connected devices, so message customization will be internally handled by Browser App.

8. Message Expiry Field in New Push Message:

Details are not given in W3c about the expiry of the message:

For example, Scores, Stock updates, Product Deals are not valid after certain period of time. So, instead of showing to user, the messages are auto-deleted after expiry time.

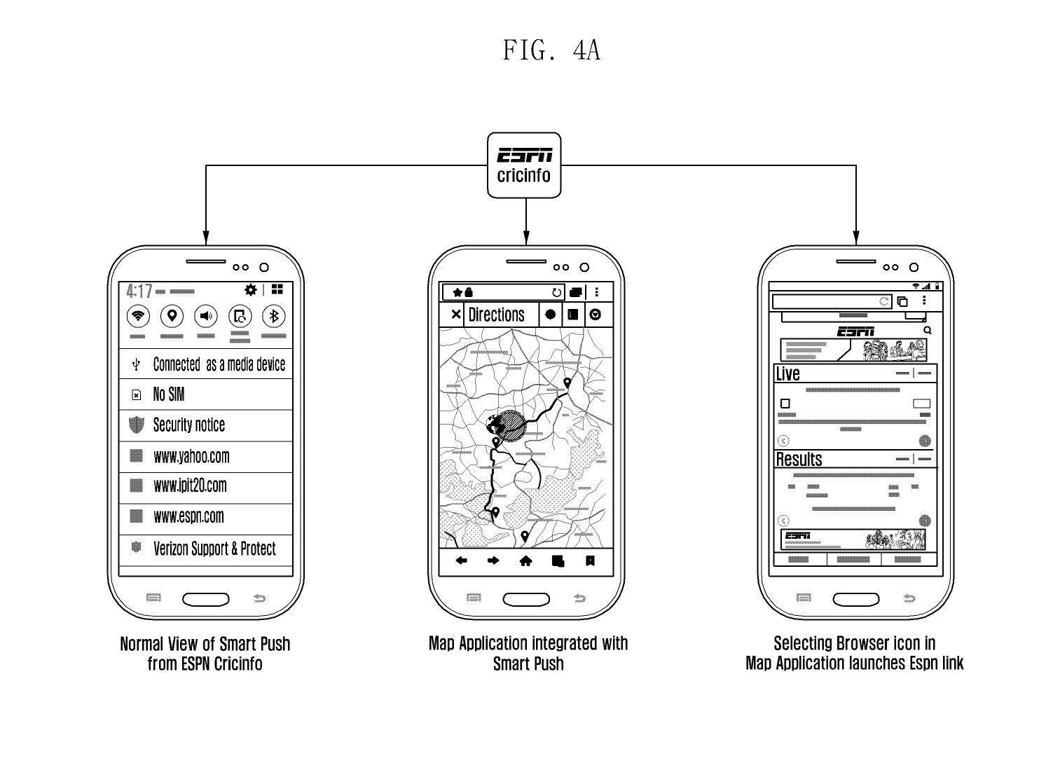

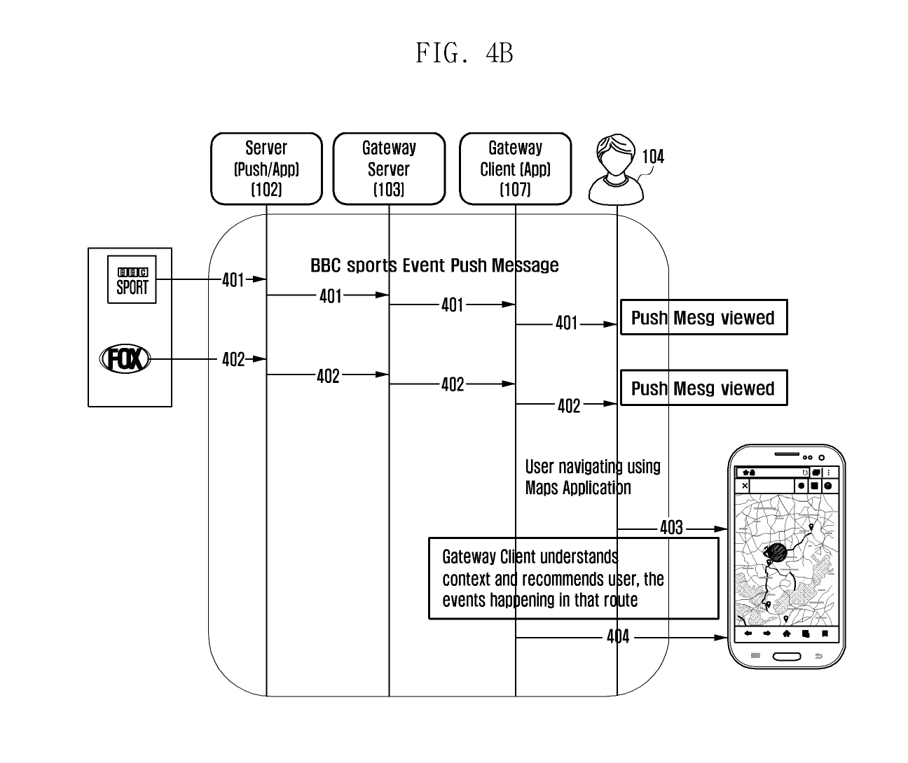

FIGS. 4A and 4B illustrates a system for providing dynamically customized web push messages showing region based ads as per the user's region or location in a wireless network according to an exemplary embodiment of the present invention. In this exemplary embodiment (FIG. 4A), the content provider sends a push message with event details and location data. When user opens a map application while travelling in the a route the map application queries user push data from the gateway client in the device and shows the push/browser icon in the maps so that user can be reminded of the event in the route. On selection of the icon launches the browser or provides the push message with the event details. Thus, the system integrates the push message contents with all the applications in the user device.

FIG. 4B illustrates a flow diagram for integration of the push with the native applications on the user device, such as the maps application according to an embodiment of the present invention. At step 401, the content provider 101 such as BBC sport sends the push message to the user through the push server, the gateway server and the gateway client. At step 402, another content provider 101 such as FOX sport sends the push message to the user through the push server, the gateway server and the gateway client. At step 403, user navigates to some other place using a map application. At step 404, the gateway client understands context and recommends the user, the event happening in that route. Depending on the location of the user, the system can recommend to the user via push notifications the events happening at that location. Similarly, the push feature can be integrated and embedded into other applications also.

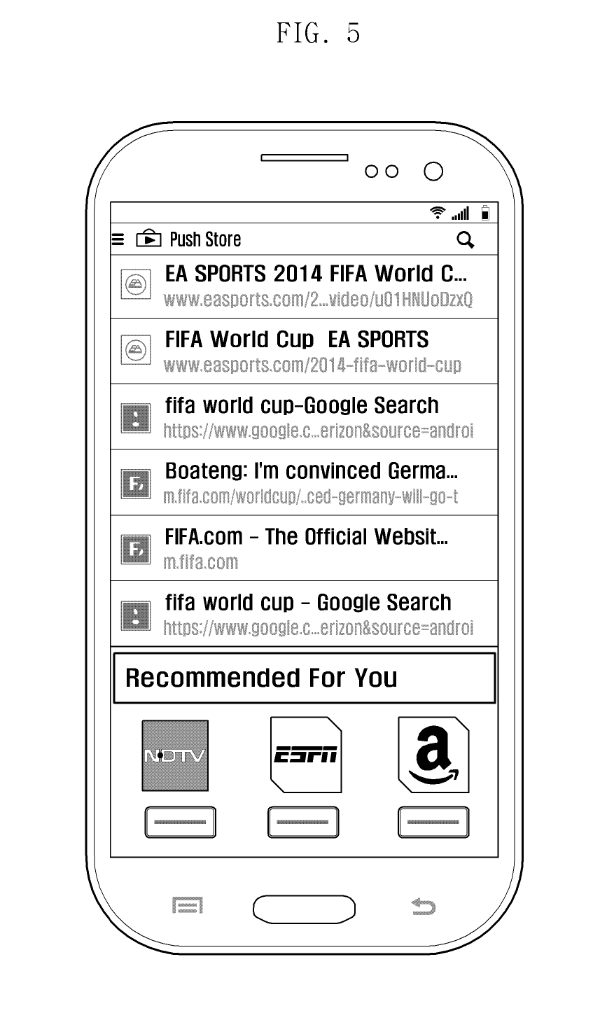

FIG. 5 illustrates a system for providing dynamically customized web push messages showing service provider recommendations based on user profile according to an exemplary embodiment of the present invention. In this embodiment, the gateway server recommends the user for one or more content providers based on a variety of parameters such as user current subscriptions with content providers, user searches in browser, user push message clicks category, user interest derived from any of the info available in the device. For example if user has subscribed to a sports website A, the gateway server can recommend trending sports content providers such as sports website B and similarly gateway server can also recommend TRENDING content provider supporting push messaging updates.

Push message recommendations include when user is travelling in a route/region where he has some valid subscription with the content provider. The content provider having events in the same location updates the gateway server periodically of the user location and recommends the events if any, in the region user is travelling. Similarly updating location information to gateway server helps user during roaming and thus helps in pushing local/region based push messages to user. Thus the system enables region based push message/content recommendation using periodic location updates to gateway server in this advanced push notification framework. The current w3c push API does not support feedback mechanism to content providers.

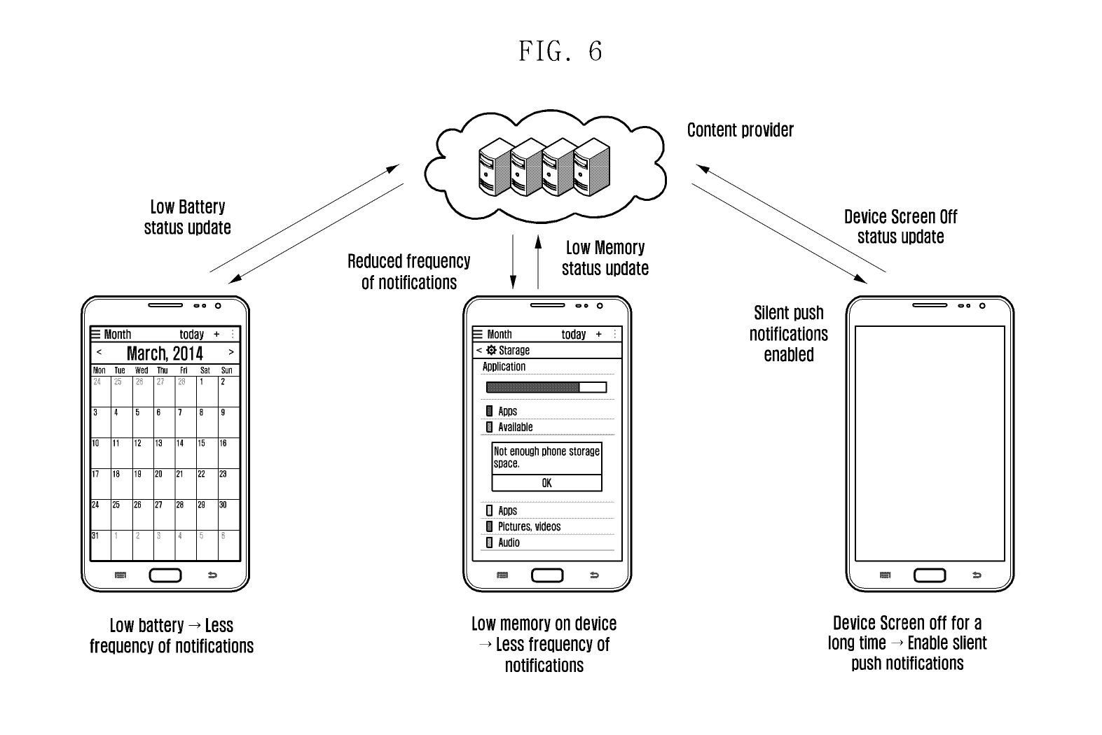

FIG. 6 illustrates a system for providing dynamically customized web push messages showing changing frequency of push messages recommendation as per device status (such as low power and low memory etc.) according to an exemplary embodiment of the present invention. In this embodiment, the gateway client updates gateway server the statistics of the device so that the gateway server can control the push flow of the messages. The gateway server only updates the content providers when there is a permanent loss of the device. For example, the gateway client updates the gateway server when the device power is low, when the device is running low on memory. Then the gateway server reduces the push flow of the messages. In another scenario if the device screen off for a long time for example during night the gateway server can enable silent push of messages. Thus the system enables device statistics update to the gateway server so that push can work smartly.

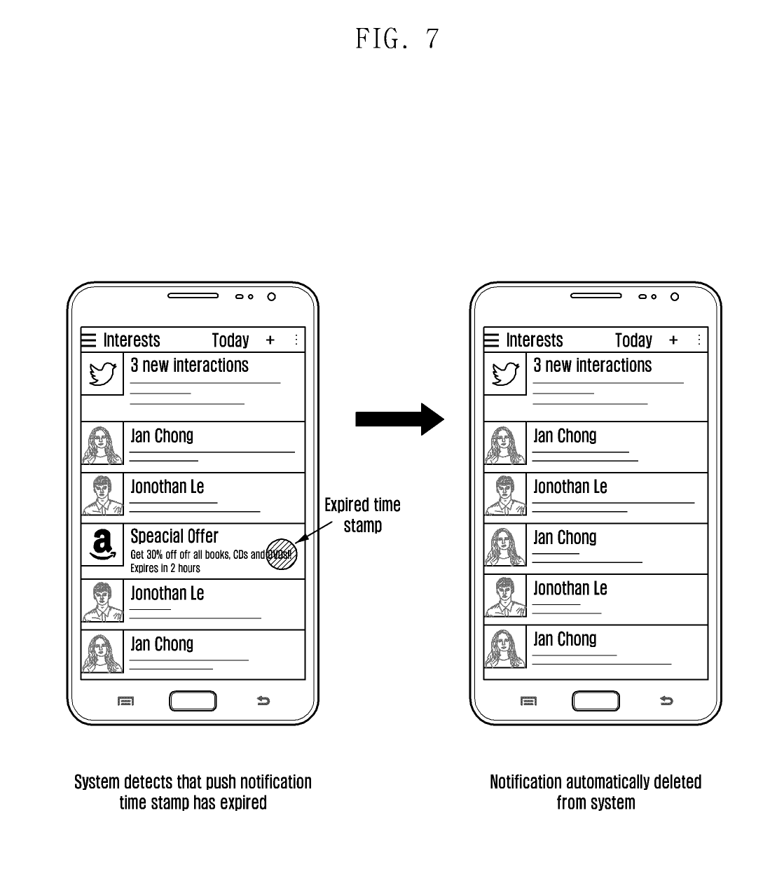

FIG. 7 illustrates a system for providing dynamically customized web push messages showing push messages getting automatically deleted based on an expired time stamp according to an exemplary embodiment of the present invention. This embodiment describes extended push message capability such as Message expiry fields where the messages gets deleted automatically as soon as they expire. The Push messages are intended to carry content deals, content updates, content offers, content ads, secure updates, privacy updates which follow a time limit (for example expiry date) and beyond that they are not valid. So if the gateway client in the device detects that the expiry date is past then it will delete the push message automatically from the device. This will enable auto deletion of the push inbox and will save memory space.

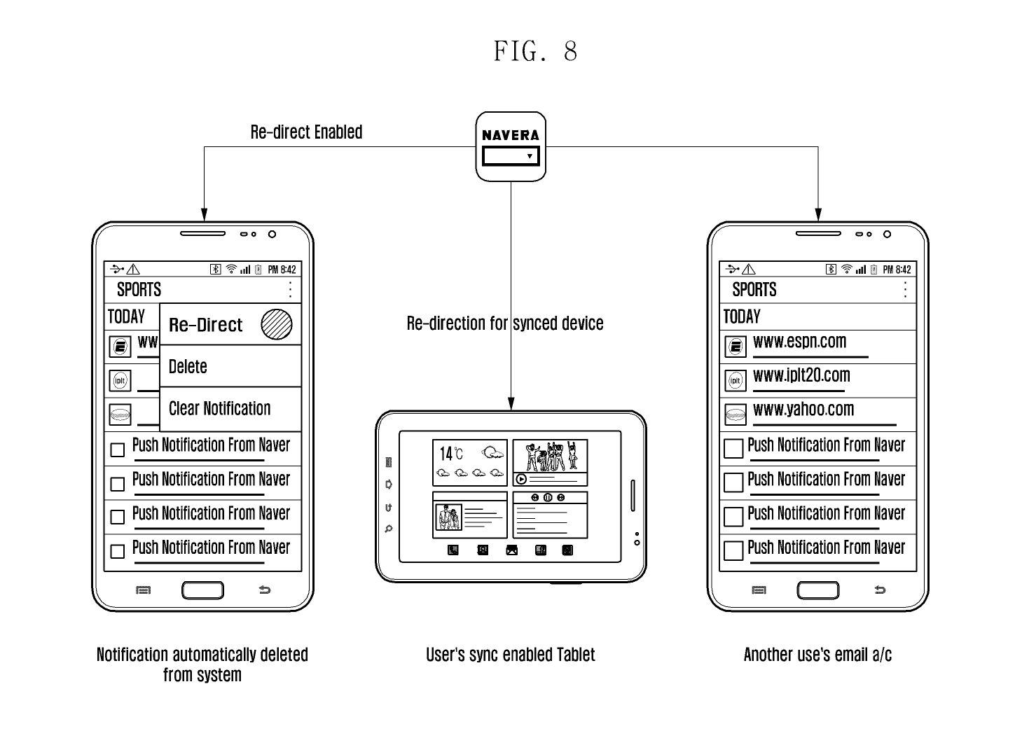

FIG. 8 illustrates a system for providing dynamically customized web push messages showing redirection of push messages to another device according to an exemplary embodiment of the present invention. In this embodiment, the gateway client is aware of which devices are connected (via Wi-Fi etc) to the current device where push messages are being sent. So the system facilitates the user to redirect the incoming messages if they wish. Otherwise if the user has read a push message on one device, the gateway client can enable the same message to be copied to all the devices owned by the user, or none, as per the user's chosen options. In another embodiment of configuring particular content provider messages routing to any of the synced device, the gateway client redirects the incoming messages to any of the connected (via Wi-Fi or such connection) or synced (where multiple devices are logged on to the same account in the cloud) devices as per the user's configuration.

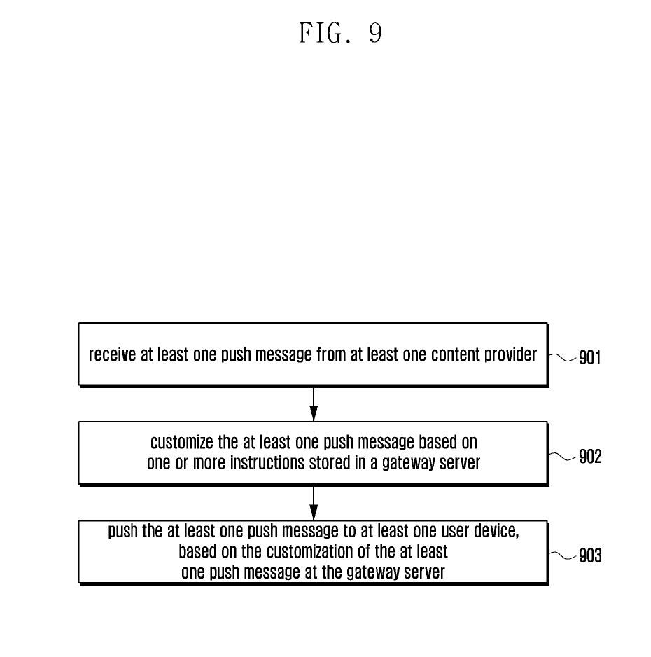

FIG. 9 illustrates a flow chart of a method of providing dynamically customized web push messages in a wireless network according to an embodiment of the present invention. At step 901, at least one push message is received from at least one content provider. At step 902, the at least one push message is customized based on one or more instructions stored in a gateway server. At step 903, the at least one push message is pushed to at least one user device based on the customization of the at least one push message at the gateway server.

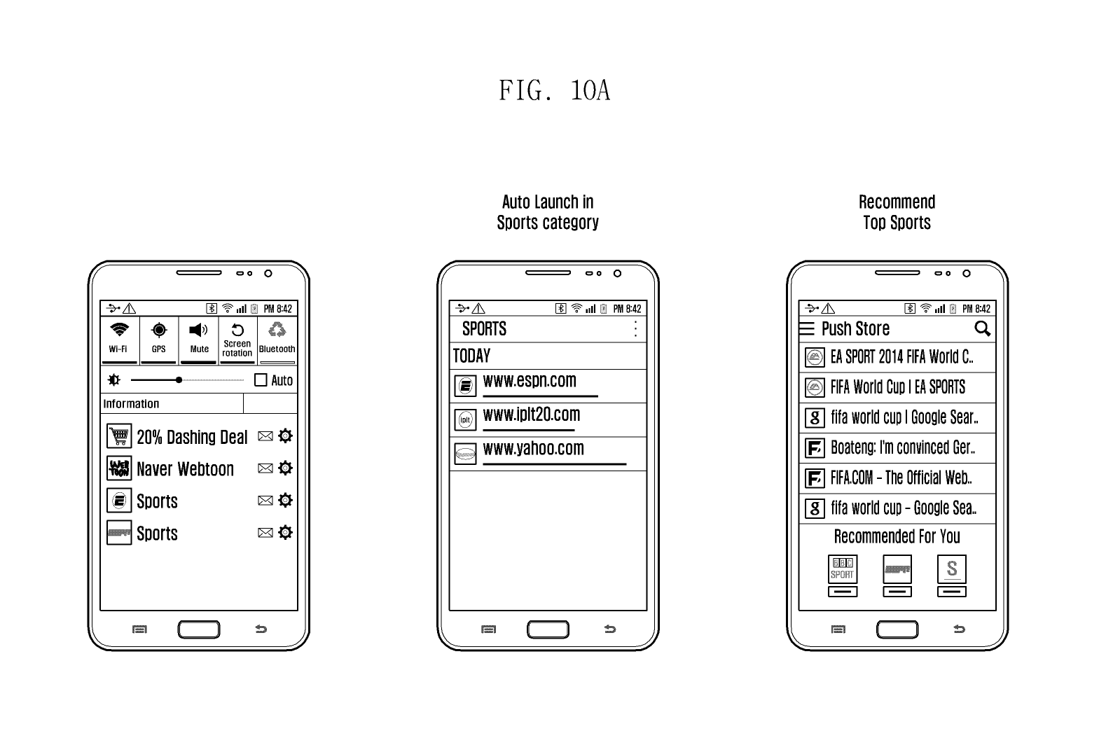

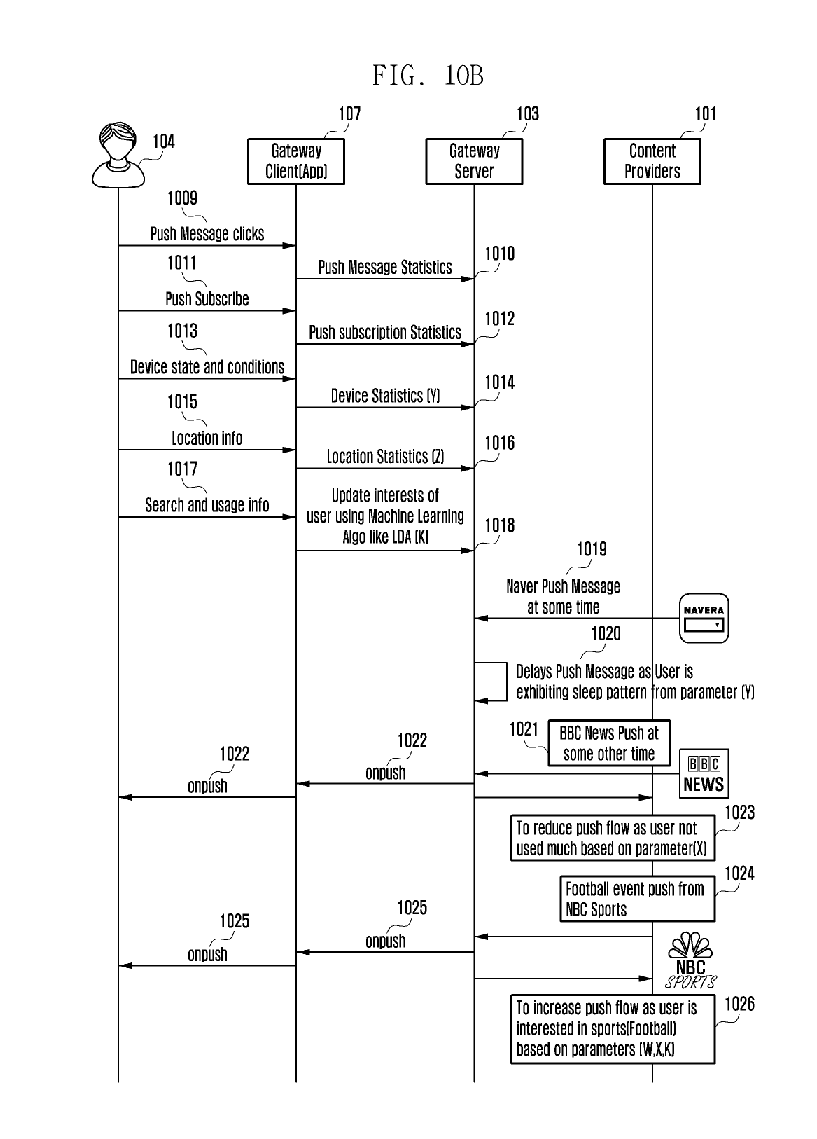

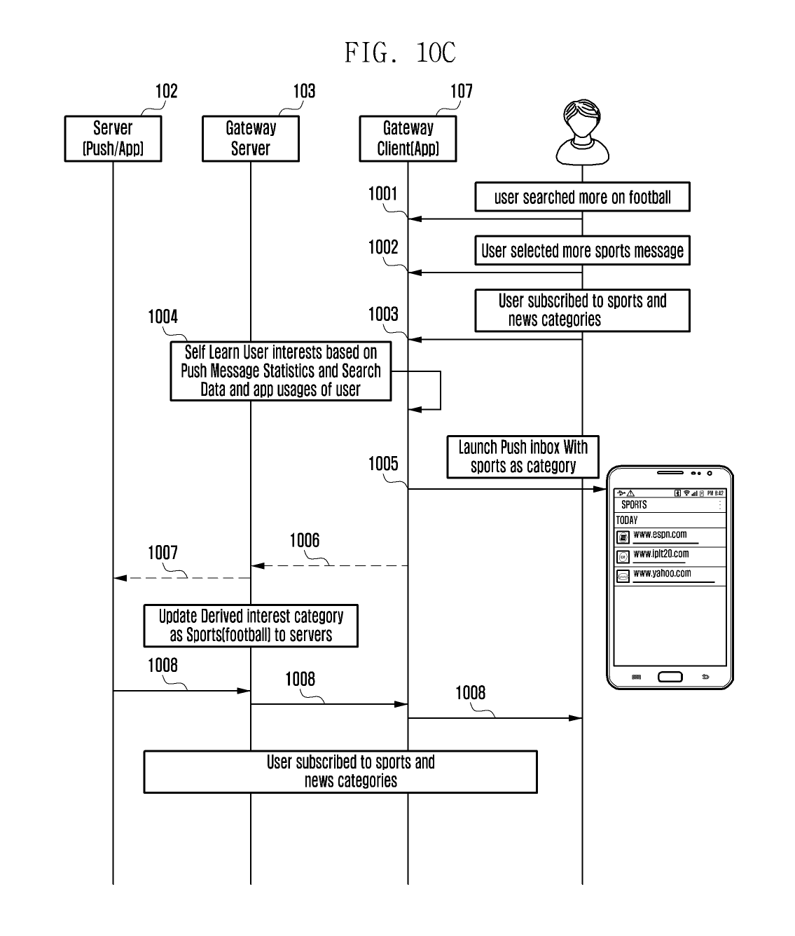

FIG. 10A to 10C illustrates a flow diagram a method of dynamically customizing at least one push message from a content provider according to an embodiment of the present invention. FIG. 10A depicts an exemplary embodiment in which the gateway client launches an inbox for sports category based on derived user interest such as sports. Subsequently, the push server sends recommended top sports push messages.

In another embodiment, the gateway server 103 learns from the user behavior to push targeted messages to the user device at the time and place when the user is more likely to open them. Here user behavior refers to the user's activity on the device including which kind of apps they are opening and which type of push messages they are more likely to open at any given time.

The learning of the user behavior is used to make predictive rules. The learning happens at two places:

At the gateway client the user behavior is recorded and a machine learning algorithm such as Latent Dirichlet Analysis (LDA) is used to classify the categories of push messages that the user is actually opening. These categories are in turn sent to the gateway server along with data such as the device usage statistics. The gateway server, which has the classified categories along with contextual factors such as the location and time, then uses machine learning to create dynamic rules of the type [contextual factor→category of push message]. The rules predict what category of message the user is likely to open at a given time and place based on the past behavior. This is used to send only targeted push messages, or delay sending some messages until the time the user is more likely to open them. For example, a rule may be defined to display news related notifications when location of the user device is “Home” and based on “Time of Day”. In another example, another rule may be defined to display notifications related to “Football” during “Football Season” months.

FIG. 10B depicts a flow diagram where user's preference/interest is derived based on usage statistics of user device learned from usage history of user according to an embodiment of the present invention. At step 1001, user conducts search more on football. At step 1002, the user selects and refers more sports messages. At step 1003, the user subscribes updates in sports and news categories. At step 1004, the gateway client 107 leans that user interest lies in sports based on push message statistics, searched data and application usages of the user. At step 1005, the gateway client 107 launches push inbox with sports as category. At step 1006, the gateway client 107 informs to the gateway server 103 about the user interest. At step 1007, the gateway server 103 updates the derived interest category as sports (particularly football) of the user to the server/push server 102. At step 1008, the push server 102 recommends more Sports and Football related push messages to the user based on the updated user interest received from the gateway server 103. In one embodiment of present invention, the push server is coupled to the content provider to enable the above mentioned features.

FIG. 10C depicts a flow diagram of the machine learning algorithm on the gateway server 103 according to an embodiment of the present invention. The gateway server 103 gets the user behavior classification from the gateway client 107 and uses it to form rules on what push messages the user is more likely to read. This information is used to increase or decrease the push flow, or delay some push messages until the time the user is predicted to read them.

At step 1009, the user clicks a push message. At step 1010, the gateway client 107 sends the statistics (W) of clicking push message by the user to the gateway server 103. At step 1011, the user subscribes to push messages. At step 1012, the gateway client 107 sends the statistics (X) of user subscription of push messages to the gateway server 103. At step 1013, the gateway client 107 determines the device state and conditions, and derives the device statistics (Y). At step 1014, the gateway client 107 sends the derived device statistics to the gateway server 103. At step 1015, the user location information is determined by the gateway client 107. At step 1016, the gateway client 107 sends the location statistics (Z) to the gateway server 103. At step 1017, the gateway client 107 derives the search and usage information of the user. At step 1018, the gateway client 107 updates interests of user (K) using a machine learning algorithm such as LDA to the Gateway server 103. At step 1019, first content provider 101 such as NAVER sends push message to the Gateway server 103. At step 1020, the gateway server 103 delays in sending push message as user is exhibiting sleeping pattern from parameter (Y). At step 1021, second content provider 101 such as BBC NEWS sends push message to the gateway server 103. At step 1022, the gateway server 103 push the BBC push message to the gateway client 107 and which in turn is sent/displayed to the user. At step 1023, the gateway server 103 instructs to the second content provider for reducing the push flow based on parameter (X). At step 1024, third content provider such as NBC Sports sends football event push messages to the gateway server 103. At step 1025, the gateway server 103 forwards the push messages related to the football event to the user through the gateway client 107. At step 1026, the gateway server sends the instruction to the third content provider 101 for increasing push flow as user is interested in sports (football) based on parameters (W,X,K).

The main benefit of the user behavior learning is that the user gets realistic push messages based on the predicted likelihood of opening the message. Instead of cluttering the push inbox with lots of messages, the user gets a few messages that are more relevant to them at that time and place. This improves user experience.

In one embodiment, the present invention describes a method of dynamically customizing at least one push message from a content provider based on one or more instructions. The method comprises retrieving information of at least one user device by a gateway client of the corresponding user device, defining a set of rules dynamically by a gateway server based on the retrieved information of the at least one user device, and regulating transmission of the at least one push message by at least one of the content provider and the gateway server based on the defined set of rules. The retrieved information comprises at least one of user's preference based on usage statistics of user device learned from usage history of user, configuration provided by user, and location of user.

The step of defining a set of rules dynamically by a gateway server based on the retrieved information of the at least one user device classifying the retrieved information by the gateway client comprises sending the classified information to the gateway server, correlating the classified information with the time, location of the user and configuration in the user device set by the user and defining a set of rules dynamically using the correlated classified information. Likewise, the step of regulating transmission of the at least one push message by at least one of the content provider and the gateway server based on the defined set of rules comprises delaying push messages from the content provider based on the defined rules and varying frequency of transmission of push messages based on the defined rule

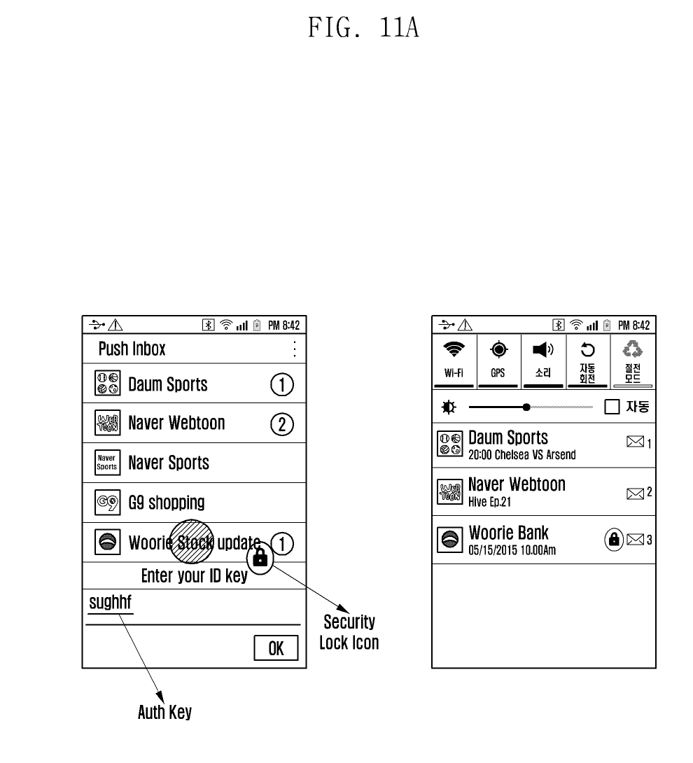

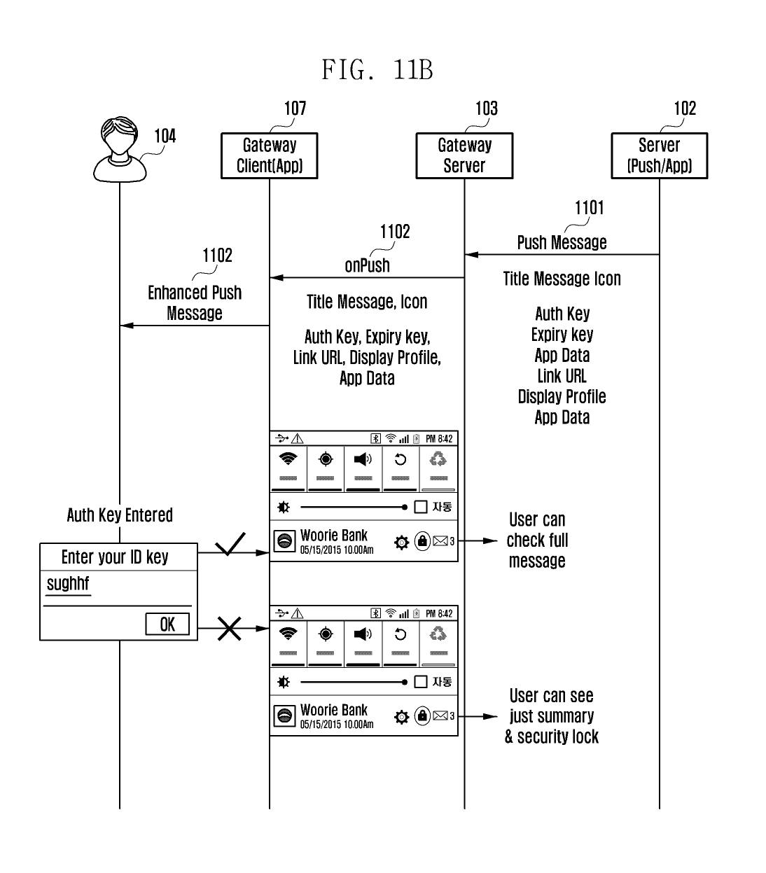

FIGS. 11A and 11B illustrates a security feature in the customized web push messages in a wireless network according to an embodiment of the present invention. When the user gets a push message from his bank, the system asks for additional authentication in the form of an ID key. The bank message is encrypted.

FIG. 11B depicts a flow diagram of providing security feature in customized web push messages in a wireless network according to an embodiment of the present invention. When a secure push message is sent, along with the title and the message icon at step 1101, the push sever sends the authorization key, expiry key, link URL, display profile and application data to the gateway server. The gateway server in turn sends the enhanced push message using the onPush( ) API to the user through the gateway client at step 1102. At step 1103, the user provides an authentication key. Once the user is authenticated, the message is decrypted and the full message displayed to the user. In the absence of extra authentication, the user can see only the summary of the message along with a security lock icon at step 1104 (as shown in FIGS. 11A and 11B).

In the conventional push systems, the additional security feature is not available and a Push Message from any content provider can be simply viewed by the user. With the additional security embodiments of the present invention, the security level (low, medium, high) of push messages is assigned based on the level of confidential data it is carrying. These levels of security can define whether a particular message can be synced or transferred to a connected device which has no secure connection. These levels of security address the privacy concern of the user. The advanced levels of security will not allow other apps to read the push message and its content which most of the apps are doing in Android system.

The content provider or the push provider determines which secure mode (low, medium or high) is for which domain. The user may also configure the security mode for a particular domain if they wish, in the security push settings.

Low security mode: In this mode, the push message is not encrypted and the user does not need extra authentication to view the push message. This applies for general push messages such as discount offers from sellers.

Medium security mode: This mode may be applied for updates from social networking sites such as Facebook. Here the message may or may not be encrypted (if not, the gateway server will encrypt) and it shows if there is a secure profile in the device (if the user is logged in). If the user is not logged in the message will not show fully.

High security mode: This mode is applies more for banking and such domains. Here the messages are always encrypted by the gateway server directly. It will not show at all unless the user performs additional authentication.

Domain Authentication

In one embodiment, the Domain authentication is needed to validate which domain the push message belongs to. For secure push messages, this needs to be performed before the user can view the actual message. This can happen in one of the following ways:

Pass URL case: Content Provider can add a Pass URL (containing Javascript which authenticates the domain) which runs at client side and authenticate whenever a push message comes whether the Push Message belongs to the same domain.

Associated URL case: The content Provider can inject an Associated URL (actual reference URL that refers to the webpage where login authentication is done) as part of the Push Message which asks user to login to the domain to ensure the user is trusted person and message reached the right owner.

No URL case: If the push messages are not properly authenticated against a proper domain, Gateway client can reject the push message or show as it is to user base on push profile selected by user.

Push Message Authentication

In order to ensure user privacy and security, the push message is provided to the user after domain authentication.

Low security: If the security of the push message is low or not mentioned by the content provider the Push message is treated as normal and will be shown as a regular push message by the Gateway client.

Medium security: If the security of the push message is medium as mentioned by the content provider or as recommended by the Gateway server based on the message content, the medium security case happens.

In the medium security level which set by the content provider, authorization key is not used.

In case the user is not authenticated, the gateway client, which knows the full message and restricts the display to the user without authentication, makes the summary of the full message by having just the domain and timestamp. If such a secure mode is not present at client, message will be considered as high level secure push message and user will be prompted to generate authenticate key or password at the content provider.

Following are the method to manage the authentication
Push message is shown to user only in private mode or any other secure mode. In all other devices modes just time stamp and domain of the push message is shown to user by the Gateway client.
If the device supports secure mode and user wants certain messages from the content provider to be shown in secure mode, user can configure via push profile settings available in Gateway client.
If such a secure mode is not present at client, message is considered as high level secure push message and user is prompted to generate authenticate key or password at content provider.

High security: If the security of the push message is considered as high as mentioned by the content provider or as recommended by the gateway server based on the message content,
Push message is shown to user only when user enters a valid authenticated key or password as generated previously at the content provider site. The Gateway client decodes the message using any cryptography algorithm mutually agreed between Gateway client and Gateway server
Gateway client shows domain and time stamp of the push message, when the user is not authenticated.

In one embodiment, the authenticate key or Pin can be generated at the content provider site and passed on to the Gateway server. The Gateway server in turn updates the Gateway client via an internal push message. The user can always regenerate the authentication key or pin at the content provider site and the same is updated to Gateway server instantly. Thus all high level secure push messages intended for user are always secured.

If content provider site does not support authenticate key generation, but user wants certain messages from a content provider to be shown only on authentication, the Gateway client can generate a key for user and the push messages is shown to the user only who generated the key. Any other user can not open the push message without having the Authenticate key or pin.

This level of secure push messages doesn't allow any applications to read the push message and thus addresses privacy and security concerns of user.

In the high security case, the gateway client, which knows the full message but restricts the display to the user without authentication, makes the summary of the full message by having just the domain and timestamp.

The advantage of having a configurable three tiered security (such as low, medium, and high security) of push messages include the following: the user privacy is maintained and confidential messages such as notices from the bank are kept safe from falling into the wrong hands due to an additional level of user authentication. The extra security prevents someone from glancing at the user's private messages by chance. Also, the fact that the medium and high security messages are encrypted by the gateway server prevents any hackers from getting access to the content of those messages. High level security messages are kept extra safe by a two level authentication based on the authentication key.

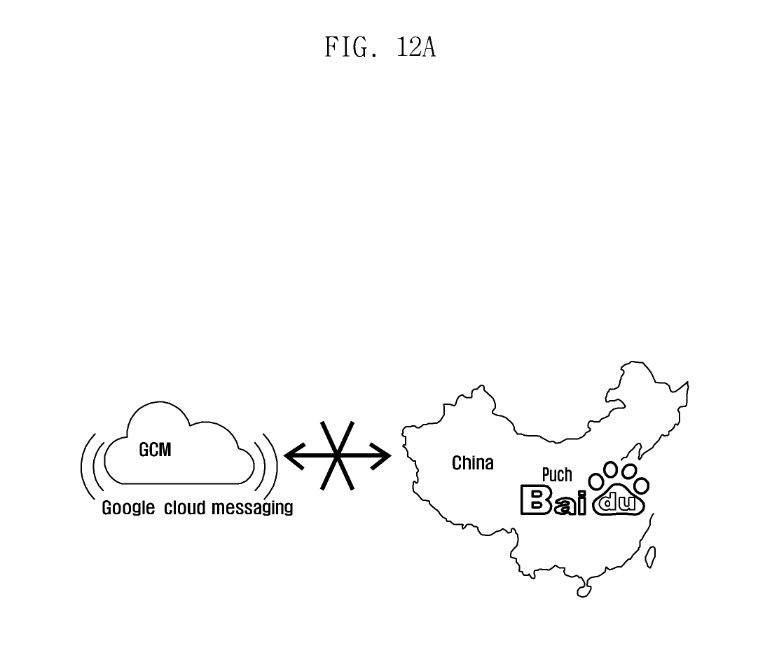

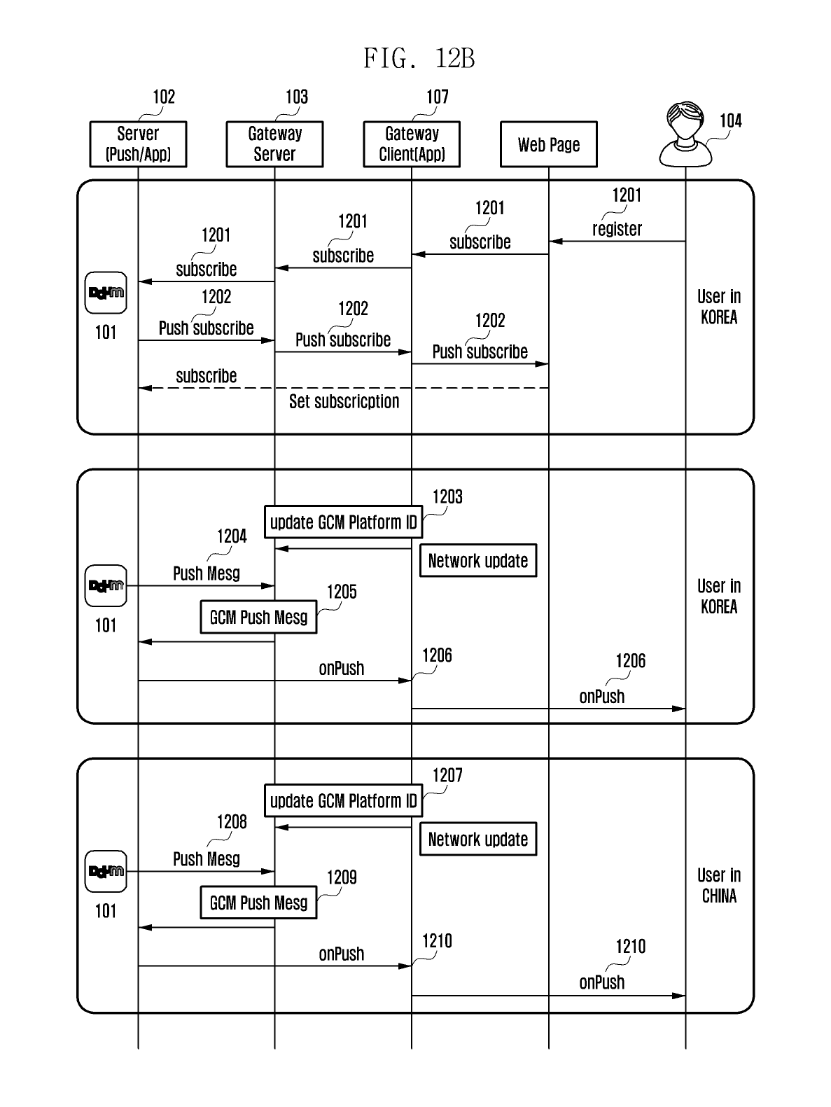

FIGS. 12A and 12B illustrates a seamless web push messages in a wireless network according to an embodiment of the present invention. In one exemplary embodiment, the user's location is Korea the normal push subscription happens during the network update, using GCM platform. When the user moves to China the network is updated and the platform is updated to Baidu.

There are multiple available push platforms such as Baidu, Google Cloud Messaging (GCM), Mozilla Simple Push and MQTT. Some push providers may be coupled to one of these push providers and all the push messages from that provider may by default be coming from that push platform only. However some of the platforms may not work in certain areas, for example the GCM may not work in China as shown in FIG. 12A, and Baidu may work there only. In the conventional system if the user goes to China the existing push subscriptions that are coupled to GCM may not work and the user would have to do a new push registration with the provider using Baidu as the GCM. But in the present invention, the seamless switching of the push provider occurs, without the user or the push server needing to know of it.

FIG. 12B depicts the flow diagram in which the gateway client update the gateway server 103 of the location of the user and the gateway server 103 determines if the push provider does not work in that location and perform a seamless switching of the push provider. At step 1201, user registers with a web page and subsequently subscription information is shared with the gateway client 107, the gateway server 107, and the push server 102. At step 1202, the push server 102 provides push subscription information to the user through the gateway server 103 and the gateway client 107. During network update, the gateway client 107 sends GCM platform ID to the gateway server 103 at step 1203. At step 1204, the content provider 101 sends the push message to the gateway server 103. At step 1205, the gateway server 103 customizes the push message according to the GCM platform and sends the GCM push message the push server 102. At step 1206, the push server 102 sends the GCM push message to the user through the gateway client 107.

For instance, when user moves to another country such as China, then the one or more available push platforms are identified by the gateway client based on the location of the user device. The push platform is switched from a first push platform to a second push platform when the first push platform is unavailable of the user device at the current location. Then the push messages are pushed seamlessly to the user device through the switched platform. For example, during network update, the gateway client sends Baidu Platform ID to the gateway server 103 at step 1207. At step 1208, the content provider 101 sends the push message to the gateway server 103. At step 1209, the gateway server 103 customizes the message according to Baidu platform and sends it to the push server 102. At step 1210, the push server 102 sends the customized push messages to the user through the gateway client 107.

With the method as described above, the Content Provider need not worry about Push Platform or smart phone platform or user roaming scenarios or about country specific policies. Additionally, the Gateway client and Gateway server is always available.

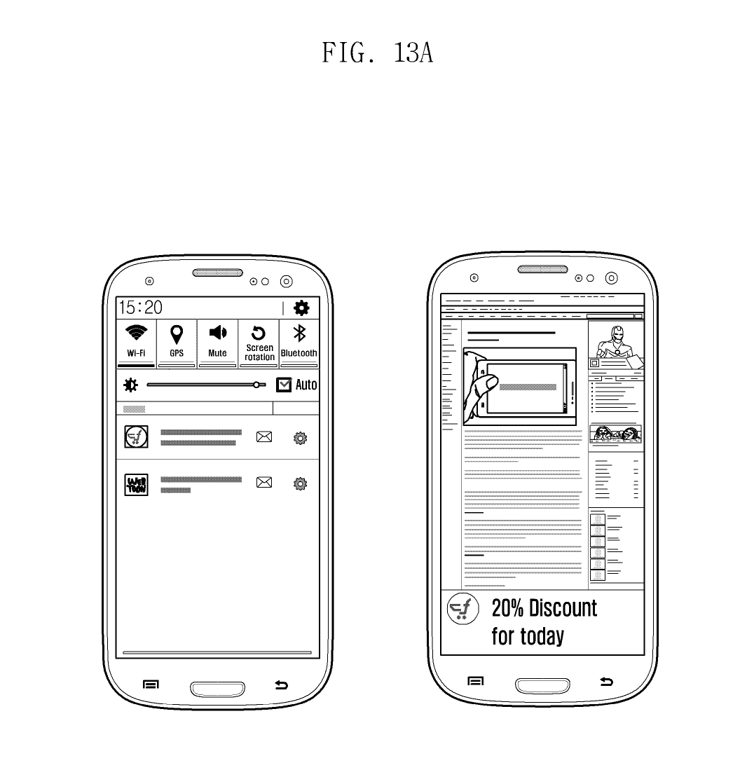

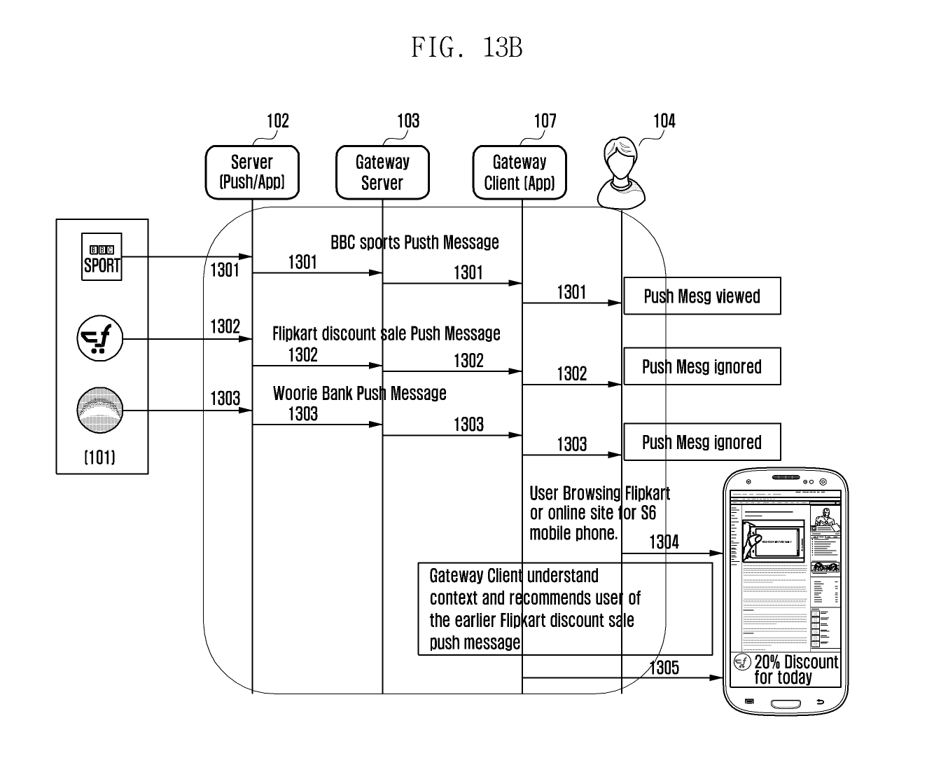

FIGS. 13A and 13B illustrates an embodiment of displaying previously stored push message relevant to the user web browsing activity according to the present invention. FIG. 13A depicts a mobile device which retrieves previously stored push messages and displays them to the user at the right time such as when user is browsing relevant product over the website. In an exemplary embodiment, the user got a push message from Flipkart for 20% discount sale on the smart phone and ignored it. However when the user is browsing a website to buy a product (say a smartphone) and previously he got a push notification that there is a 20% discount on the same smartphone. At that time the user might have ignored it or read it and done no action. So now the gateway server 103 determines that the previously stored push message is relevant for this website being browsed and so pops up the message at this time.

In another exemplary embodiment, the user device 104 displays previously stored relevant push message according to the user's location. For example, if the device 104 determines (via GPS sensor or such method) that the user's location is a shop for mobile phones, and there is a previously stored push message relevant to that location e.g. discounts for smartphones. Then the device 104 pops up that message at that time.

In yet another exemplary embodiment, the user device 104 displays previously stored relevant push message according to the time of day or as per user's calendar. For example, the device knows that the user is scheduled now to have an appointment with the ophthalmologist. The user previously got a push message stating 20% off new glasses or frames. So at that time the system will pop up that push message.

In one embodiment, the present invention describes a method of popping up at least one push message from a plurality of stored message in a user device. The method comprises analyzing information of user device, wherein the information comprises at least one of a location of the user device, Real time web browsing activity perfumed in the user device and, calendar schedule stored in the user device, fetching at least one push message from a plurality of stored message in a user device corresponding to analyzed information, and displaying the fetched at least one push message.

FIG. 13B illustrates a flow diagram displaying/popping-up previously stored push message relevant to the user based user web browsing activity according to the present invention. At step 1301, the content provider such as BBC Sport sends a push message to the user through the push server 102, the gateway server 103, and the gateway client 107. Subsequently, the push message is viewed by the user. At step 1302, the content provider such as flipkart sends the discount sale push message to the user through the push server 102, the gateway server 103, and the gateway client 107, which is ignored by the user. At step 1303, the content provider such as woorie bank sends the push message to the user through the push server 102, the gateway server 103, and the gateway client 107, which is again ignored by the user. At step 1304, the user brows the flipkart website or online site for S6 mobile phone, At step 1305, the gateway client 107 understand the context and recommends user about the earlier flipkart discount sale push message.

In order to achieve the above mentioned embodiment, the gateway client 107 finds the relevant information using the sensors on the device 104 and accessing the user's calendar etc. The gateway client 107 then determines which previously stored push message is relevant for this context and pops it up. The advantage of this embodiment includes but not limited to the following: the user need not remember what kind of push messages he received, need not search for any sale or coupon codes available now. Push messages is retrieved and Push Message pop-up happens based on the current context.

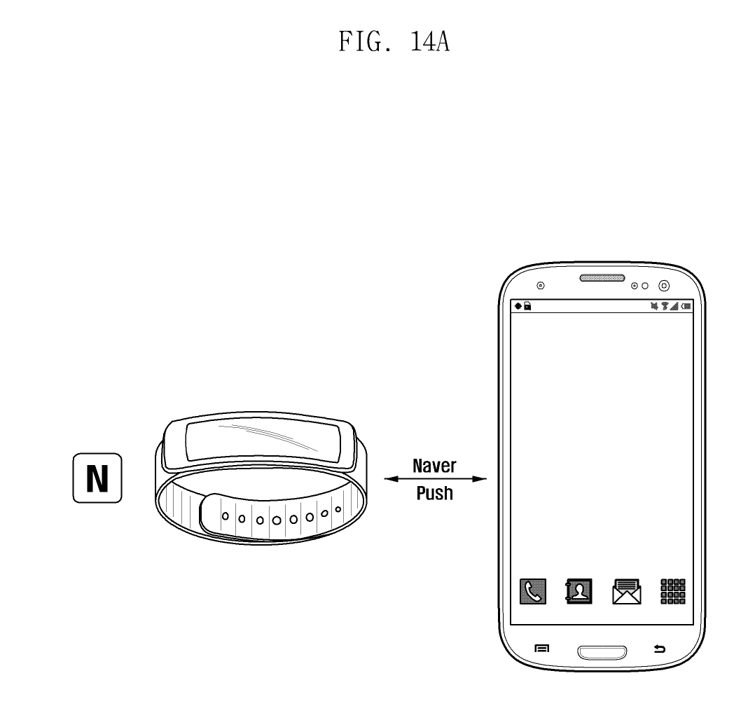

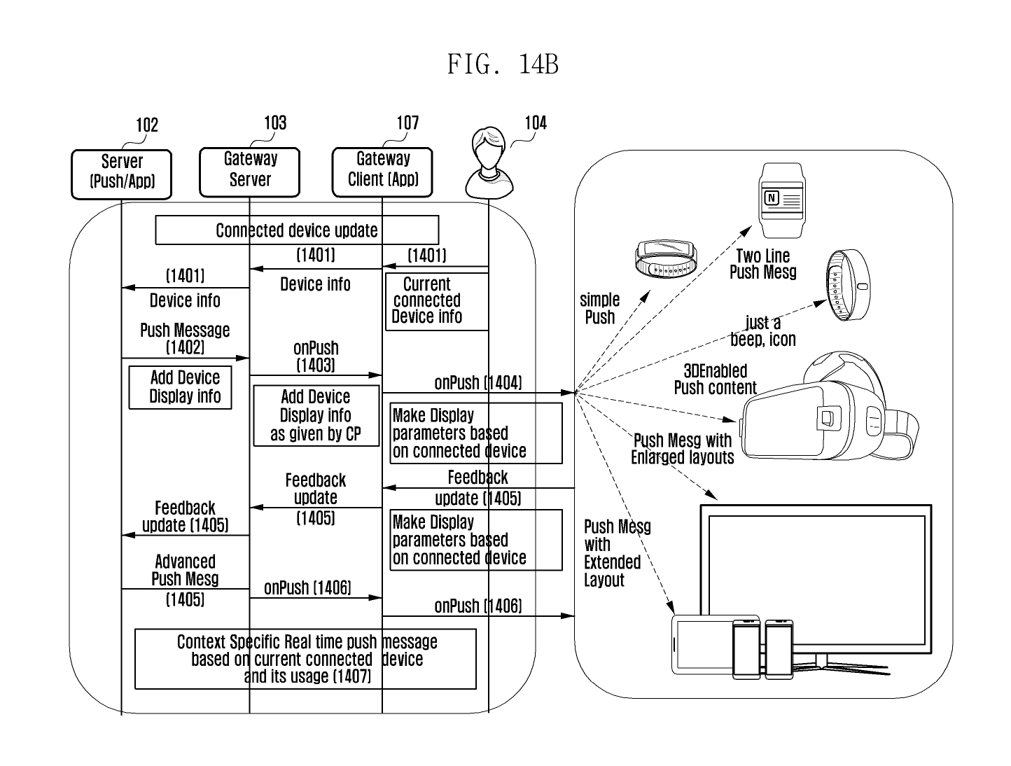

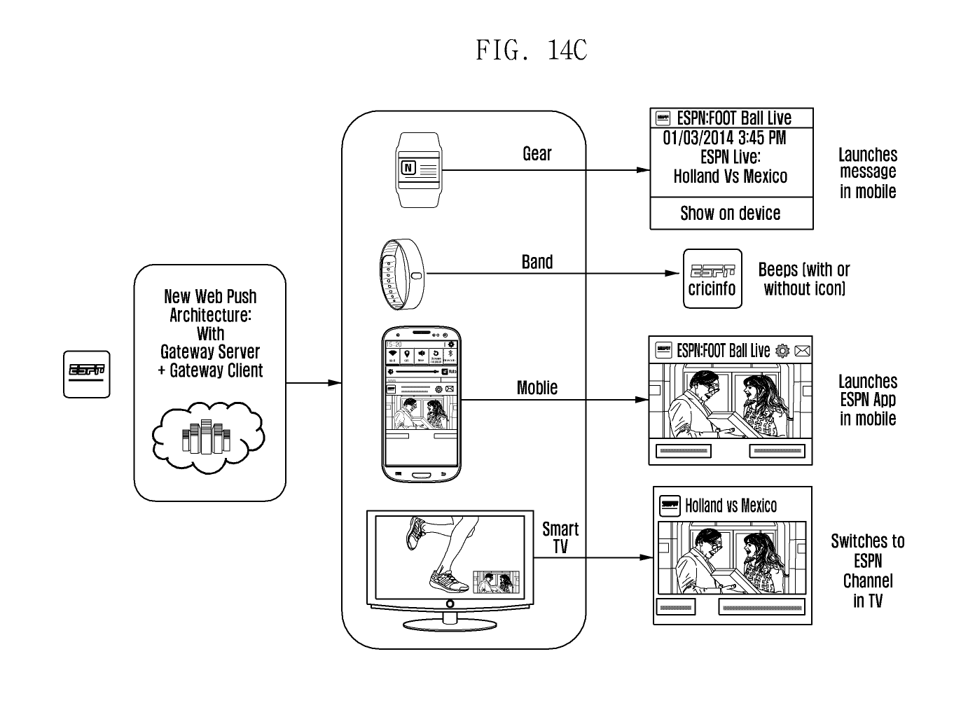

FIG. 14A to 14C illustrates a method of dynamically customizing the at least one push message from a content provider based on feedback received from one or more connected devices according to the present invention. In this embodiment (as shown in FIG. 14A to 14B), the same push message is displayed with different look and feel on the different connected device (which includes but not limited to gear, TV, VR headset) depending on the type of connected device and its display capabilities.

During connected device update, the current connected device information is shared with the push server through a gateway server at step 1401. At step 1402, the push server sends the push message along with the device display information to the gateway server. At step 1403, the gateway server pushes the message to the gateway client along with display information as given by the content provider. At step 1404, the gateway client pushes the customized message to the connected device according to the display parameter of the respective connected devices. At step 1405, the gateway client receives the feedback update and forwards the same to the push server through the gateway server. At step 1406, the push server sends context specific real time push message based on the collected feedback to the connected devices.

FIG. 14C shows how a push message from the same push provider (say ESPN cricket info) appears in different user devices. For a Gear wearable, a small icon appears (which can be displayed in the space available on gear). For a wristband, the push message is indicated by just a beep or a small icon. For a mobile smartphone the push message appears bigger and comes with a shortcut to access the related ESPN app in the mobile phone. For a TV the message comes with a shortcut to open the ESPN channel (using the program guide to perform the mapping between the channel number and the push provider).

This is made possible by an architecture where the connected devices themselves send the display and other settings to the push provider rather than passing through an intermediate main device such as the smartphone.

The server needs feedback from the connected devices for the following reasons:
To recommend Push Message to user based on the current connected device
To provide appropriate icons as suited to the connected device
To provide live content as per the current connected device
To recommend alternate 3D content based on the connected 3D device like 3D TV, Glasses etc.
To provide UI display Layouts as suited for the connected device.
To control push flow based on the device feedback updated
To avoid duplicate push messages on the connected device feedback.

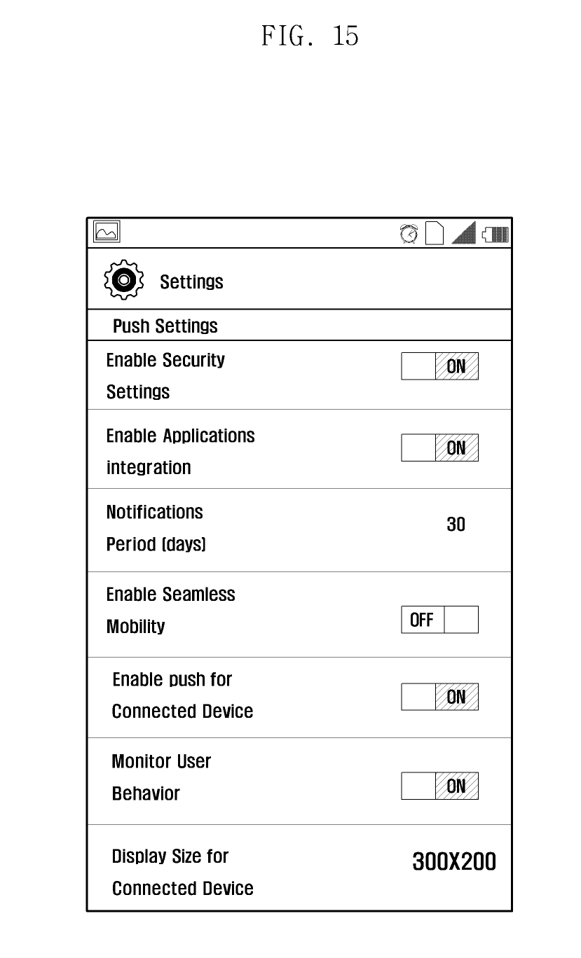

FIG. 15 illustrates a user interface for enabling the user to configure settings according to advanced push features according to an embodiment of the present invention. The user may enable or disable or configure individual settings for features which includes but not limited to security, applications integration, seamless mobility, connected devices, turn user monitoring on or off etc.

According to an embodiment, the complete list of settings includes the following:
Enable Security Settings
Configure Notification Period
Enable Maps Integration
Enable Seamless Mobility
Enable Auto Suspension of messages (not viewed for long time)
Display as Widget
Enable Push Messages Sync for connected/offline devices
Enable Learning of User Behavior
Monitor when device is unused
Push settings for connected devices
Display size
Monitor when device connected
Push read messages to each connected device
Push only unread messages

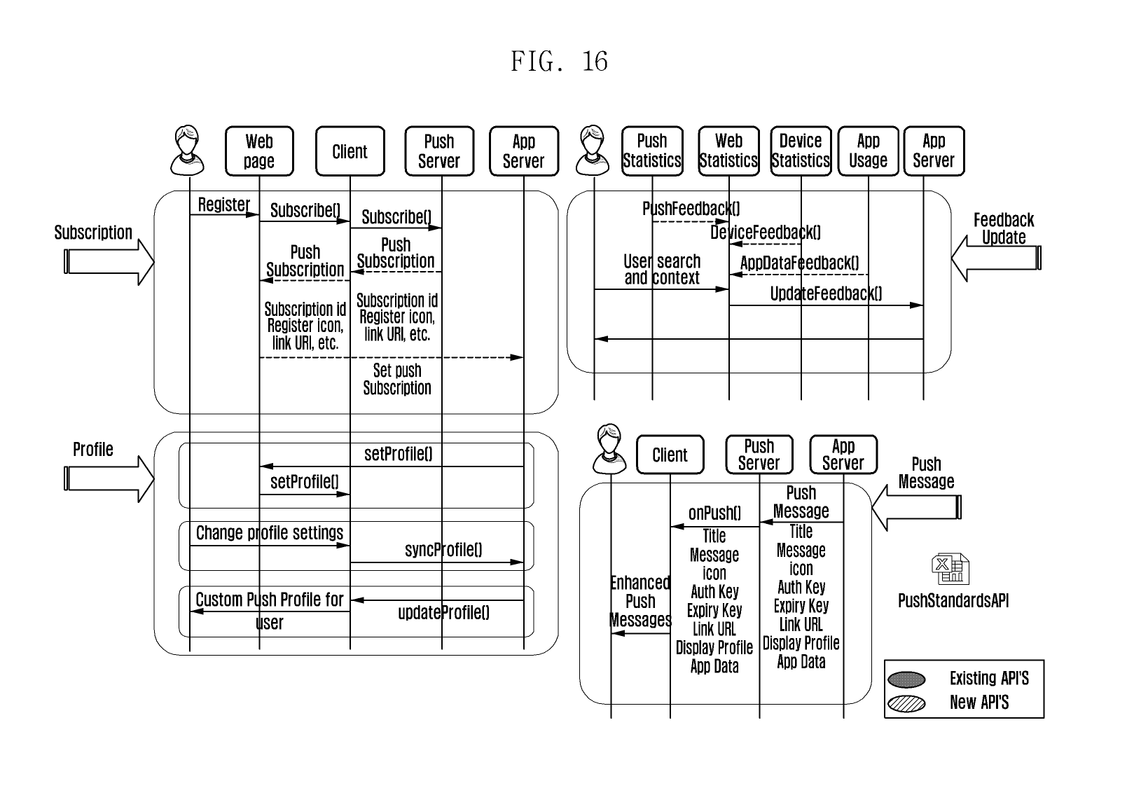

FIG. 16 illustrates the main push APIs for subscription, feedback update and profile. The APIs for registration are register and subscribe. For feedback update from the device to the gateway server, the APIs are pushFeedback, deviceFeedback, appDataFeedback and updateFeedback. For profile settings the APIs are setProfile, syncProfile and updateProfile.

According to the present invention, the customization of push message provides following features:

1. Content providers can tailor the messages to the specific user, even if multiple users are using the same device.

2. Security and authentication that the user is indeed logged in, is also done at the content provider URL on the client side before providing the push messaging.

These can be implemented by using extra authentication parameters in the new Message and get it validated by the pass URL.

3. The icons etc. can be dynamically changed/updated from the content provider without the user having to download a new version of the app

This can be implemented using the Update( ) API provided with data as Json Parameters.

4. The content provider can tailor the frequency of push messages as per the battery usage (low battery=less frequency)

5. Based on user's context (such as the user's browsing activity), the push messages can be customized for one particular user

This can be implemented using ReUpdate( ) api functionality provided by client.

6. Push messages for connected devices (with user context and device based customizations) can be done in following ways:
6.1 if the user subscribes on one device, other devices can also get the same push messages.
6.2 Also when one device is disconnected, the push messages are targeted at any currently connected devices for the same user
6.3 Based on user preferences, the server will deliver the push messages to the user device based on at least one of the following:

(a) either all the user's devices or to some of them, or

(b) only those devices that are online, or

(c) prioritize them based on type of device.

These can be implemented by constantly updating the connected device info to the content providers using ReUpdate( ) api functionality.

7. Multiple content providers can provide push messages dynamically based on the user's areas of interest (if the user is interested in clothes special offers based push messages/notification and has subscribed for one company such as Jabong® then other companies like EBay® or Flipkart® or Amazon® which provide can provide the same products can also push their offers, as long as the user has subscribed to both). This can be implemented using ReUpdate( ) api functionality provided by client.

8. If the push message refers to an event or shopping offer that has expired or is no longer valid, it is automatically deleted from the user's device

This can be implemented using the Message Expiry field in new Push Message.

9. Based on stastical data of each messages of the service such as how much time the user takes to click a push message, what types of messages user reads, the system learns from the user's past usage and prioritizes the messages and types of messages to send.

This can be implemented using Reupdate( ) api functionality provided by client. Client can periodically sends to content provider about the statistics of the messages received.

10. The content provider can decide the layout, color, font etc. of the push notification as displayed on the user's device, as per the user's device capabilities.

This can be implemented using the update( ) API functionality provided by the client. Additionally, the content provider can even push a policy for layout display.

11. The content provider can push region based messages (such as ads) as per the user's region.

This can be implemented using ReUpdate( ) api functionality provided by client.

12. The content provider can use the device sensors to provide targeted push messages (for example if the user is travelling or it is night time or user is sleeping, the push message can be deferred, similarly location in office or time of day can be used).

This can be implemented using Reupdate( ) api functionality provided by client.

13. The user can have options to redirect his subscribed messages to another device or even another user (such as a friend or family member).

This can be implemented using the Reupdate( ) api provided by the client. Client can have UI to address these preferences and these can be updated to the content provider.

14. Content Provider can choose sending of the push message to the target app or user login or user profile of the device apart from content provider login.

This can be implemented using the register( ) with extra Jason Parameters to identify the target app or profile.

15. Content Provider can join an existing service and send group messages rather than sending individual messages to device. This methodology allows the re-use existing services and resources.

For example: All finance messages can be grouped while sending and receiving and while displaying to user they can be stripped apart.

This can be implemented by using the join( ) method provided by client. This API enables the content provider to send group messages and on the other side client is able to process the messages together.

16. The content Provider can inject policy in benefit of user such that auto-suspension of the subscription happens upon certain number of messages rejection. Similar the user should be able to set auto-renewal after certain duration of time.

This can be implemented using the update( ) API provided by client.

17. Content Provider can also choose messages to persist or not at the device based on the type and priority of the service.

This can be implemented by adding extra Jason parameters as part of the new push message.

18. Content Provider can also choose to display the messages based on the type of category. For example, Yahoo Domain has multiple services such as sports, finance etc.

This can be implemented by adding extra Jason parameters as part of the new push message. The client should process and show the styled view based on category.

(Grouping can also be achieved on the client side, but at the cost of additional power and memory usage).

19. Content Provider can also issue additional filters for user to choose for receiving of messages based on certain limits. ex: user can set a filter to receive push messages only if stock price has crossed xxx or some deal price has become less than yyy etc.

This can be achieved by using Update and Re-update functions.

20. User is provided with an option to set some criteria for continuous live notification messages (such as number of updates in a unit of time exceeds a certain threshold). The messages are displayed in a special widget instead of the normal display mechanism. These widgets are not permanent but are time bound based on the service provided (e.g. cricket updates last for a few hours while stocks updates last for a full day). On the expiration of the time, the widgets will automatically be removed from the system.

This can be achieved by using update (such as for getting the display policy and filter policy) and reupdate (such as to update any abnormal shutdown of the widget by the user) functions.

An aspect of the present disclosure may include a method of providing dynamically customized web push messages in a wireless network, the method including: receiving at least one push message from at least one content provider; customizing the at least one push message based on one or more instructions stored in a gateway server; and pushing the at least one push message to at least one user device, based on the customization of the at least one push message at the gateway server.

The method may include customizing the at least one push message for enabling delivery of the at least one push message to an user even if multiple users are using the same device.

The method may further include authenticating a user by the content provider before providing the at least one push message.

The method may further include redirecting the message to another device or synced device or another user based on at least one of a user configuration and subscription.

The method may include customizing the at least one push message by one of a content provider and intermediate server based on at least one of a feedback, statistics and usage results received from the at least one user device.

The method may further include providing user preference to at least one of a content provider and sync server.

The method may include the at least one push message provided by the content provider is synced with the at least one user device based on at least one of a device sync option and accounts sync option.

The method may further include configuring the at least one push message by a master user device as per the needs of one or more connected devices if the one or more connected device is not governed by one of the content provider and intermediate server, for providing additional features and functionalities.

The method may further include providing updated feedback, and statistics from the connected device to at least one of the content provider and intermediate server.

The method may further include dynamically providing a plurality of push messages based on at least one of the user's area of interest and usage statistics, where user's area of interest and usage statistics are determined based on at least one of users browsing history, user search patterns in browser and device, connected device, user content subscription patterns, shopping patterns, search patterns, data usage patterns, voice usage patterns, user installed application types, user usages of apps, user choice of sharing content including media files, pdf files to other user and devices.

The method may include customizing the at least one push message comprises configuring one or more parameters in the at least one push message for auto deletion from the user's device once a scheduled event time expires, as well as auto update of the push message.

The method may include wherein customizing the at least one push message comprises configuring one or more parameters in the at least one push message in order to customize appearance and presentation of the at least one push message.

The method may include pushing the at least one push message to at least one user device based on at least one of user's region, user's subscription, battery usage, application installed in the device, available memory and signals received from device sensor.

The method may include customizing the at least one push message comprises configuring one or more policies in the at least one push message.

The method may include the one or more policies comprises at least one of a display policy, sync policy, location update policy, grouping policy, security policy, and message filtering policy.

The method may further include recommending the user with updating trends of the at least one of the content provider and change in the agreement, where updating trends comprises top trending charts, top trending services, top trending topics

The method may include customizing the at least one push message includes at least one of a integrating the at least one push message with one or more applications in the device in order to provide dynamic update to the user; dynamically changing an icon without the user having to download a new version of the application and providing the user an option to either select or reject follow up sub-content.

The method may include customizing the at least one push message based on user's context, the user's context comprises at least one of a user's browsing activity, and user's subscription to services.

An another aspect of the present disclosure may include a system for providing dynamically customized web push messages in a wireless network, the system including: at least one content provider; at least one push server for pushing the at least one push message to at least one user device; a gateway server coupled to the at least one content provider, the at least one push server, and the at least one user device having a gateway client for customizing the at least one push message based one or more instructions stored at the gateway server.

The system may include the at least one user device includes at least one push client corresponding to the at least one push server for enabling communication between the at least one push server and the at least one user device.

The system may include the at least one user device include at least one gateway client corresponding the at least one gateway server for enabling communication between the at least one gateway server and the at least one user device.

The system may include the at least one gateway client is configured to include one or more features, the feature is selected from a group comprises extended push user interface, push inbox, extended push settings, push configuration of connected devices, push profiles of content providers, push widgets, push privacy of the at least one content providers and the at least one user.

The system may include the at least one user device comprises an interface for customizing the at least one push message in order to pass API calls to the gateway server,

where the gateway server is configured to change at least one of a content, policy, profile and subscription on the basis of the one or more parameters received from the at least one user device.

The system may include the at least one user device comprises a customized widget for displaying the at least one push message, the customized widget is time bound and automatically gets removed from the at least one user device once time expires.

The system may include the at least one user device is configured to process a request received from one or more connected devices in order to provide the processed request to the one or more content providers.

The system may include the at least one user device is configured to receive feedback from the one or more connected devices in order to provide the feedback to the one or more content providers.

An another aspect of the present disclosure may include a method of dynamically customizing at least one push message from a content provider, the method including: retrieving information of at least one user device by a gateway client of the corresponding user device; defining a set of rules dynamically by a gateway server based on the retrieved information of the at least one user device; and regulating transmission of the at least one push message by the gateway server based on the defined set of rules.

The method may include the retrieved information comprises at least one of user's preference based on usage statistics of user device learned from usage history of user, configuration provided by user, and location of user.

The method may further include configuring at least one security setting for each domain by at least one of a user, gateway server, and content provider.

The method may include the security settings comprises at least one of a low, medium, and high.

The method may include displaying the at least one message when the security setting is configured as low.

The method may include displaying header of the at least one message when the security setting is configured as one of a medium and high in absence of user authentication.

The method may include displaying the at least one message on user being authenticated when the security setting is configured as one of a medium and high.

The method may include the at least one push message is encrypted by the gateway server when the security setting is configured as one of a medium and high.

The method may further include a key based authentication for providing as additional authenticating feature when the security setting is configured as high, where the key based authentication is based on content provider and user.

The method may include defining a set of rules dynamically by a gateway server based on the retrieved information of the at least one user device including: classifying the retrieved information by the gateway client; sending the classified information to the gateway server; correlating the classified information with the time, location of the user and configuration in the user device set by the user; and defining a set of rules dynamically using the correlated classified information.

The method may include regulating transmission of the at least one push message by at least one of the content provider and the gateway server based on the defined set of rules including at least one of: delaying push messages from the content provider based on the defined rules; and varying frequency of transmission of push messages based on the defined rule.

The method may further include identifying one or more available push platform by the gateway client based on the location of the user device; switching the push platform from a first push platform to a second push platform when the first push platform is unavailable of the user device; and pushing seamlessly the at least one push message to at least one user device.

The method may include the configuration provided by the user comprises enabling at least one a security setting, application integration, notifications period, seamless mobility, push for connected devices, and monitoring user behavior.

The method may include regulating transmission of the at least one push message by at least one of the content provider and the gateway server further including: receiving device information of the one or more connected devices from the user device; customizing the at least one push message provided by at least one of the gateway client and the content provider based on the received device information; and transmitting the customized push message to the one or more connected device by the user device.

The method may include the device information comprises at least one of a, nature of device, display information, and available memory.

An another aspect of the present disclosure may include a method of popping up at least one push message from a plurality of stored message in a user device including: analyzing information of user device, wherein the information comprises at least one of a location of the user device, real time web browsing activity, and calendar schedule stored in the user device; fetching at least one push message from a plurality of stored message in a user device corresponding to analyzed information; and causing to display the fetched at least one push message.

Advantages:

The system of the present invention is for embedded devices/platforms which does not support web-apps. This is a hybrid approach on top of the w3c editorial draft which ensures the below advantages in terms of power and security to the end user with the help of an extended browser app.

The following are some of the advantages of this invention regarding the push messages:
There is no need to have multiple web-apps for each service.
There is no need to have platform support for registering of Push messages and receiving of Push Messages.
When a push message (of type general) comes, there is no need to launch browser app to get it processed. This way additional power will not be consumed.
When a push message comes which is needs previous login credentials it can be passed as part of the message. In such a case the browser app can authenticate itself or with the help of the Associated URI registered earlier. This operation can be done by keeping browser in background. This way power consumption is reduced.
When a push message comes which contains no data and is secure type then Browser app will send to Associate URI which has mechanism to get authenticated by user. Thus this framework ensures extended security before displaying a notification to user. If user rejects to authenticate then the message can be ignored.
With respect to security, this invention gives additional security since we allow the app (pass URL) to validate the new message with the user credentials.

Although the invention of the method and system has been described in connection with the embodiments of the present invention illustrated in the accompanying drawings, it is not limited thereto. It will be apparent to those skilled in the art that various substitutions, modifications and changes may be made thereto without departing from the scope and spirit of the invention.

What is claimed is:

1. A method of providing dynamically customized web push messages in a wireless network, the method comprising:
receiving at least one push message from at least one content provider;
customizing the at least one push message based on one or more instructions stored in a gateway server; and
pushing the at least one push message to at least one user device, based on the customization of the at least one push message at the gateway server.

2. The method of claim 1, wherein customizing the at least one push message for enabling delivery of the at least one push message to a user even if multiple users are using the same device.

3. The method of claim 1, further comprising authenticating a user by the content provider before providing the at least one push message.

4. The method of claim 1, further comprising redirecting the message to another device or synced device or another user based on at least one of a user configuration and subscription.

5. The method of claim 1, wherein customizing the at least one push message by one of a content provider and intermediate server based on at least one of a feedback, statistics and usage results received from the at least one user device.

6. The method of claim 1, further comprising providing user preference to at least one of a content provider and sync server.

7. The method of claim 1, wherein the at least one push message provided by the content provider is synced with the at least one user device based on at least one of a device sync option and accounts sync option.

8. The method of claim 1, further comprising configuring the at least one push message by a master user device as per the needs of one or more connected devices if the one or more connected device is not governed by one of the content provider and intermediate server, for providing additional features and functionalities.

9. The method of claim 1, further comprising providing updated feedback, and statistics from the connected device to at least one of the content provider and intermediate server.

10. The method of claim 1, wherein customizing the at least one push message comprises configuring one or more parameters in the at least one push message for auto deletion from the user's device once a scheduled event time expires, as well as auto update of the push message.

11. The method of claim 1, wherein customizing the at least one push message comprises configuring one or more parameters in the at least one push message in order to customize appearance and presentation of the at least one push message.

12. The method of claim 1, wherein customizing the at least one push message comprises configuring one or more policies in the at least one push message.

13. The method as claimed in claim 1, wherein customizing the at least one push message comprises at least one of:
integrating the at least one push message with one or more applications in the device in order to provide dynamic update to the user;
dynamically changing an icon without the user having to download a new version of the application; and
providing the user an option to either select or reject follow up sub-content.

14. A system for providing dynamically customized web push messages in a wireless network, the system comprising:
at least one content provider;
at least one push server for pushing the at least one push message to at least one user device; and
a gateway server coupled to the at least one content provider, the at least one push server, and the at least one user device having a gateway client for customizing the at least one push message based one or more instructions stored at the gateway server.

15. The system of claim 14, wherein the at least one user device comprises at least one push client corresponding to the at least one push server for enabling communication between the at least one push server and the at least one user device.

16. The system of claim 14, wherein the at least one user device comprises at least one gateway client corresponding the at least one gateway server for enabling communication between the at least one gateway server and the at least one user device.

17. The system of claim 14, wherein
the at least one user device comprises an interface for customizing the at least one push message in order to pass API calls to the gateway server, and
wherein the gateway server is configured to change at least one of a content, policy, profile and subscription on the basis of the one or more parameters received from the at least one user device.

18. The system of claim 14,
wherein the at least one user device comprises a customized widget for displaying the at least one push message, and
wherein the customized widget is time bound and automatically gets removed from the at least one user device once time expires.

19. The system of claim 14, wherein the at least one user device is configured to process a request received from one or more connected devices in order to provide the processed request to the one or more content providers.

20. The system of claim 14, wherein the at least one user device is configured to receive feedback from the one or more connected devices in order to provide the feedback to the one or more content providers.

21. A method of dynamically customizing at least one push message from a content provider, the method comprising:
retrieving information of at least one user device by a gateway client of the corresponding user device;
defining a set of rules dynamically by a gateway server based on the retrieved information of the at least one user device; and
regulating transmission of the at least one push message by the gateway server based on the defined set of rules.

22. The method of claim 21, wherein the retrieved information comprises at least one of user's preference based on usage statistics of user device learned from usage history of user, configuration provided by user, and location of user.

23. The method of claim 21, further comprising configuring at least one security setting for each domain by at least one of a user, gateway server, and content provider, and wherein the security settings comprises at least one of a low, medium and high.

24. The method of claim 23, wherein displaying the at least one message when the security setting is configured as low, and
displaying header of the at least one message when the security setting is configured as one of a medium and high in absence of user authentication.

25. The method of claim 23, wherein displaying the at least one message on user being authenticated and the at least one push message is encrypted by the gateway server, when the security setting is configured as one of a medium and high.

26. The method of claim 21, wherein defining a set of rules dynamically by a gateway server based on the retrieved information of the at least one user device comprises:
classifying the retrieved information by the gateway client;
sending the classified information to the gateway server;
correlating the classified information with the time, location of the user and configuration in the user device set by the user; and
defining a set of rules dynamically using the correlated classified information.

27. The method as claimed in claim 21, wherein regulating transmission of the at least one push message by at least one of the content provider and the gateway server based on the defined set of rules comprises at least one of:
delaying push messages from the content provider based on the defined rules; and
varying frequency of transmission of push messages based on the defined rule.

28. The method as claimed in claim 21, further comprising:
identifying one or more available push platform by the gateway client based on the location of the user device;
switching the push platform from a first push platform to a second push platform when the first push platform is unavailable of the user device; and
pushing seamlessly the at least one push message to at least one user device.

29. The method as claimed in claim 21, wherein the configuration provided by the user comprises enabling at least one a security setting, application integration, notifications period, seamless mobility, push for connected devices, and monitoring user behavior.

30. The method as claimed in claim 21, wherein regulating transmission of the at least one push message by at least one of the content provider and the gateway server further comprising:
receiving device information of the one or more connected devices from the user device;
customizing the at least one push message provided by at least one of the gateway client and the content provider based on the received device information; and
transmitting the customized push message to the one or more connected device by the user device.
